(19) United States
(12) Patent Application Publication
(10) Pub. No.: US 2024/0334349 A1
(43) Pub. Date: Oct. 3, 2024

(54) WIRELESS COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Wenhong CHEN, Dongguan (CN); Zhihua SHI, Dongguan (CN); Zhi ZHANG, Dongguan (CN)

(21) Appl. No.: 18/737,472

(22) Filed: Jun. 7, 2024

Related U.S. Application Data
(63) Continuation of application No. PCT/CN2021/143077, filed on Dec. 30, 2021.

(51) Int. Cl. H04W 52/36; H04W 16/28; H04W 72/1268; H04W 76/20; H04W 80/02

(52) U.S. Cl. CPC H04W 52/365; H04W 16/28; H04W 52/367; H04W 72/1268; H04W 76/20; H04W 80/02

(57) ABSTRACT

A wireless communication method includes: receiving, by a terminal device, power headroom report (PHR) configuration information; reporting, by the terminal device, a target PHR according to the PHR configuration information.

### CROSS-REFERENCE TO RELATED APPLICATION

This application is a continuation application of International Application No. PCT/CN2021/143077, filed on Dec. 30, 2021, which is incorporated herein by reference in its entirety.

### TECHNICAL FIELD

Embodiments of the present disclosure relates to the field of communication, and in particular, to a wireless communication method, a terminal device, and a network device.

### BACKGROUND

In the New Radio (NR) system, a terminal device may report power headroom report (PHR) to a network device, and the PHR may be determined according to a transmission power of a physical uplink shared channel (PUSCH) or a sounding reference signal (SRS). The PHR may be used to assist the network device in configuring a power control related parameter, but a frequent reporting of PHR will increase a signaling overhead. Therefore, how to report a PHR is a problem that needs to be solved urgently.

### SUMMARY

In a first aspect, there is provided a wireless communication method, including: receiving, by a terminal device, power headroom report (PHR) configuration information; reporting, by the terminal device, a target PHR according to the PHR configuration information.

In a second aspect, there is provided a wireless communication method, including: transmitting, by a network device, power headroom report (PHR) configuration information; receiving, by the network device, a target PHR.

In a third aspect, there is provided a terminal device for performing the method in the above first aspect or various implementations thereof.

Optionally, the terminal device includes a functional module for performing the method in the above first aspect or various implementations thereof.

In a fourth aspect, there is provided a network device for performing the method in the above second aspect or various implementations thereof.

Optionally, the network device includes a functional module for performing the method in the above second aspect or various implementations thereof.

In a fifth aspect, there is provided a terminal device, including a processor and a memory. The memory is configured to store a computer program, and the processor is configured to call and run the computer program stored in the memory to perform the method in the above first aspect or various implementations thereof.

In a sixth aspect, there is provided a network device, including a processor and a memory. The memory is configured to store a computer program, and the processor is configured to call and run the computer program stored in the memory to perform the method in the above second aspect or various implementations thereof.

In a seventh aspect, there is provided a chip for implementing the method in any one of the above first aspect to second aspect or various implementations thereof.

Optionally, the chip includes: a processor, configured to call and run a computer program from a memory, causing a device installed with the apparatus to perform the method in any one of the above first aspect to second aspect or various implementations thereof.

In an eighth aspect, there is provided a non-transitory computer readable storage medium for storing a computer program, where the computer program causes a computer to perform the method in any one of the above first aspect to second aspect or various implementations thereof.

In a ninth aspect, there is provided a computer program product including computer program instructions, where the computer program instructions cause a computer to perform the method of any one of the above first aspect to second aspect or various implementations thereof.

In a tenth aspect, there is provided a computer program, where the computer program, upon being executed on a computer, causes the computer to perform the method in any one of the above first aspect to second aspect or various implementations thereof.

### BRIEF DESCRIPTION OF THE DRAWINGS

FIG. 1 is a schematic diagram of an architecture of a communication system provided by embodiments of the present disclosure.

FIG. 2 is a schematic diagram of an uplink transmission based on multi-TRP provided by the present disclosure.

FIG. 3 is a schematic diagram of another uplink transmission based on multi-TRP provided by the present disclosure.

FIG. 4 is a schematic diagram of a PUCCH transmission based on multi-TRP provided by the present disclosure.

FIG. 5 is a schematic diagram for configuring a TCI state provided by the present disclosure.

FIG. 6 is a schematic interaction diagram of a wireless communication method provided by the embodiments of the present disclosure.

FIG. 7 is a diagram of a MAC CE format for carrying a single-cell PHR provided by the embodiments of the present disclosure.

FIG. 8 is a diagram of a MAC CE format for carrying multi-cell PHRs provided by the embodiments of the present disclosure.

FIG. 9 is a diagram of a MAC CE format for carrying multi-cell PHRs provided by the embodiments of the present disclosure.

FIG. 10 is a schematic diagram of a method for determining a PUSCH for carrying multi-cell PHRs provided by the embodiments of the present disclosure.

FIG. 11 is a schematic diagram of a PUSCH for determining a PHR of a cell provided by the embodiments of the present disclosure.

FIG. 12 is a schematic diagram of a PUSCH for determining a PHR of a cell provided by the embodiments of the present disclosure.

FIG. 13 is a schematic block diagram of a terminal device provided by the embodiments of the present disclosure.

FIG. 14 is a schematic block diagram of a network device provided by the embodiments of the present disclosure.

FIG. 15 is a schematic block diagram of a communication device provided by the embodiments of the present disclosure.

FIG. 16 is a schematic block diagram of a chip provided by the embodiments of the present disclosure.

FIG. 17 is a schematic block diagram of a communication system provided by the embodiments of the present disclosure.

### DETAILED DESCRIPTION

Technical solutions in the embodiments of the present disclosure will be described below with reference to the accompanying drawings in the embodiments of the present disclosure. Obviously, the described embodiments are merely some but not all of embodiments of the present disclosure. For the embodiments of the present disclosure, all other embodiments obtained by the ordinary skilled in the art belong to the protection scope of the present disclosure.

Technical solutions according to embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), a wireless fidelity (WiFi), a 5th-Generation (5G) communication system, and other communication systems.

Generally, traditional communication systems support a limited quantity of connections, and are easy to implement. However, with the development of communication technology, mobile communication systems will not only support traditional communication, but also support, for example, device to device (D2D) communication, machine to machine (M2M) communication, machine type communication (MTC), vehicle to vehicle (V2V) communication, and vehicle to everything (V2X) communication, and the embodiments of the present application may be applied to these communication systems as well.

Optionally, the communication systems in the embodiments of the present application may be applied to a carrier aggregation (CA) scenario, a dual connectivity (DC) scenario, or a standalone (SA) networking scenario.

Optionally, the communication system in the embodiments of the present disclosure may be applied to an unlicensed spectrum, where the unlicensed spectrum may also be considered as a shared spectrum; or, the communication system in the embodiments of the present disclosure may also be applied to a licensed spectrum, where the licensed spectrum may also be considered as an unshared spectrum.

The embodiments of the present application are described in combination with a network device and a terminal device. The terminal device may also be referred to as a user equipment (UE), an access terminal, a subscriber unit, a subscriber station, a mobile station, a mobile platform, a remote station, a remote terminal, a mobile device, a user terminal, a terminal, a wireless communication device, a user agent or a user apparatus.

The terminal device may be a station (STA) in the WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next generation communication system (e.g., an NR network), or a terminal device in a future evolved public land mobile network (PLMN) network, etc.

In the embodiments of the present application, the terminal device may be deployed on land including indoor or outdoor, handheld, wearable or vehicle-mounted; alternatively, the terminal device may be deployed on water (such as on ships); alternatively, the terminal device may be deployed aerially (such as in airplanes, balloons and satellites).

In the embodiments of the present application, the terminal device may be a mobile phone, a pad, a computer with wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like.

As an example rather than a limitation, the terminal device in the embodiments of the present application may be a wearable device. The wearable device may also be referred to as a wearable smart device, which is a general term of wearable devices developed by intelligent design and development on daily wear by applying wearable technology, such as glasses, gloves, watches, clothing and shoes. The wearable device is a portable device that is worn directly on a body, or integrated into clothes or accessories of users. The wearable device is not only a hardware device, but also a device implementing powerful functions through software support as well as data interaction or cloud interaction. Generalized wearable smart devices include devices which are fully functional, have large sizes, and may implement complete or partial functions without relying on smart phones, such as smart watches or smart glasses, and devices (such as various smart bracelets, and smart pieces of jewelry for monitoring physical signs) which focus on a certain kind of application functions only and need to be used in conjunction with other devices (such as smart phones).

In the embodiments of the application, the network device may be a device used for communicating with a mobile device. The network device may be an access point (AP) in WLAN, a base station (BTS) in GSM or CDMA, a base station (NB) in WCDMA, an evolved base station (eNB or eNodeB) in LTE, or a relay station or access point, or a vehicle-mounted device, a wearable device, and a network device (gNB) in an NR network, or a network device in a future evolved PLMN network, or a network device in an NTN network, etc.

As an example rather than a limitation, the network device in the embodiments of the present application may have mobile characteristics. For example, the network device may be a mobile device. Optionally, the network device may be a satellite, or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may be a base station disposed in a position on land, in a water region and the like.

In the embodiments of the present application, the network device may provide a service for a cell, and the terminal device communicates with the network device through a transmission resource (e.g., a frequency-domain resource, which is also referred to as a spectrum resource) used by the cell. The cell may be a cell corresponding to the network device (e.g., a base station), and the cell may belong to a macro base station, or may belong to a base station corresponding to a small cell. The small cells herein may include a metro cell, a micro cell, a pico cell, a femto cell, and the like. These small cells are characterized by a small coverage range and a low transmission power, and are suitable for providing high-speed data transmission services.

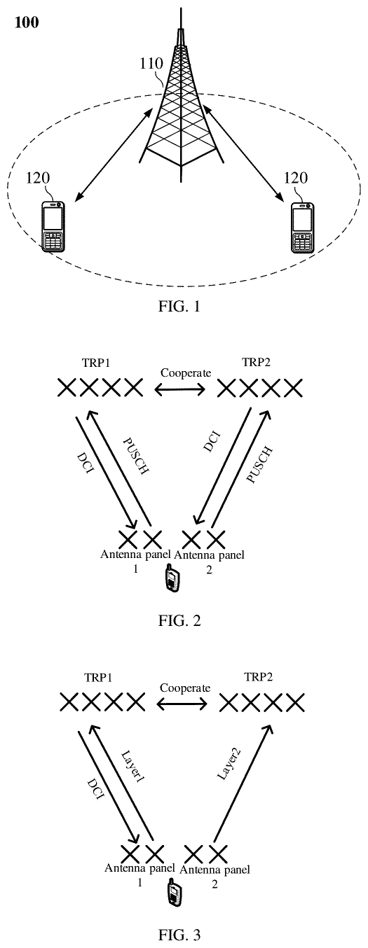

For example, a communication system 100 applied in the embodiments of the present disclosure is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area, and may communicate with a terminal device located within the coverage area.

FIG. 1 exemplarily shows one network device and two terminal devices, and optionally, the communication system 100 may include a plurality of network devices and a coverage range of each network device may include another number of terminal devices, the embodiments of the present disclosure are not limited thereto.

Optionally, the communication system 100 may also include other network entities such as a network controller and a mobility management entity, etc., which are not limited in the embodiments of the present disclosure.

It should be understood that devices with communication functions in the network/system in the embodiments of the present disclosure can be called communication devices. Taking the communication system 100 shown in FIG. 1 as an example, the communication device 100 may include the network device 110 and the terminal devices 120 with communication function, and the network device 110 and the terminal devices 120 may be the specific devices described above, which will not be repeated herein; the communication device may also include other devices in the communication system 100, such as a network controller, a mobility management entity, and other network entities, which are not limited in the embodiments of the present disclosure.

It should be understood that the terms “system” and “network” are often used interchangeably herein. The term “and/or” herein is only an association relationship to describe associated objects, which indicates that there may be three kinds of relationships, for example, A and/or B may indicate three cases where: A exists alone, both A and B exist, and B exists alone. In addition, a character “/” herein generally indicates that related objects before and after “/” are in an “or” relationship.

It should be understood that “indication” and variations thereof involved in embodiments of the present disclosure may be a direct indication, may be an indirect indication, or may represent an association relationship. For example, A indicating B may mean that A indicates B directly, for example, B can be acquired through A; or A indicating B may mean that A indicates B indirectly, for example, A indicates C, and B can be acquired through C; or A indicating B may mean that there is an association between A and B.

In the description of the embodiments of the present disclosure, the term “correspond” and variations thereof may mean that there is a directly corresponding relationship or an indirectly corresponding relationship between two parties, or mean that there is an association between two parties, or mean a relationship such as indicating and being indicated, or configuring and being configured.

In the embodiments of the present disclosure, the term “predefined” and variations thereof may be achieved by pre-storing corresponding codes, tables or other approaches that can be used to indicate relevant information in the devices (for example, including the terminal device and the network device), and the specific implementation is not limited in the present disclosure. For example “predefined” may refer to what is defined in the protocol.

In the embodiments of the present disclosure, the “protocol” may refer to a standard protocol in the field of communication, which may include, for example, an LTE protocol, an NR protocol, and related protocols applied in a future communication system, which will not be limited thereto in the present disclosure.

To facilitate the understanding of the technical solutions of the embodiments of the present disclosure, a power control mechanism related to the present disclosure is described. 1. Physical uplink shared channel (PUSCH) power control

A power control mechanism of PUSCH includes two parts: an open-loop power control and a closed-loop power control. The open-loop power control parameter is configured or reconfigured by a network device through a radio resource control (RRC) signaling, which is a slow and semi-static power adjustment. The closed-loop power control can quickly adjust a power through physical layer signaling downlink control information (DCI).

A transmission power of a PUSCH can be expressed by the following formula (1):

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( \text{} j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + Δ \text{?} ( i ) + {f}_{b , f , c} ( i , l )\end{matrix} \} \qquad Formula ( 1 )$$

$$\text{?} \text{indicates text missing or illegible when filed}$$

A unit of a transmission power of the PUSCH is dBm.
b: denotes a bandwidth part (BWP);
f: denotes a carrier (for example, an uplink (UL) carrier or a supplementary uplink carrier (SUL) within a cell);
c: denotes a serving cell;
i: denotes a transmission occasion;
j: denotes a parameter configuration index;
q_{d}: an index of a reference signal used for path loss measurement;
l: an index of a closed-loop power control adjustment state;

The open-loop power control parameters in the above formula include:
P_{O_PUSCH,b,f,c}(j): denotes a target receiving power;
α_{b,f,c}(j): denotes a weighting factor of a path loss;
PL_{b,f,c}(q_{d}): denotes a path loss value measured according to the reference signal used for a path loss;

The closed-loop power control parameters in the above formula include:
f_{b,f,c}(i, l): denotes a closed-loop power control adjustment state, including a cumulative closed-loop power control (acting on a power control cumulative value through a accumulator) and an absolute closed-loop power control (directly acting on a power adjustment value);

Other power control parameters include:
P_{CMAX,f,c}(i): denotes a maximum transmission power of the terminal device in the carrier f of in the serving cell c;
M_{RB,b,f,c}^{PUSCH}(i): denotes a transmission bandwidth of the PUSCH (the number of resource blocks (RBs) allocated by a resource).

If a DCI includes a sounding reference signal resource indication (SRI) domain, and if an NR supports configuring a mapping relationship between an open-loop power parameter, a closed-loop power parameter and the SRI domain in the DCI through an RRC signaling, the open-loop power parameter and the closed-loop power parameter are indicated by a state in the SRI domain in the DCI.

### 2. Physical Uplink Control Channel (PUCCH) Power Control

A transmission power of a PUSCH can be expressed by the following formula (2):

$${P}_{PUCCH , b , f , c} ( i , {q}_{u} , {q}_{d} , l ) = min \{ \begin{matrix}{P}_{CMAX , f , c} ( i ) , \\ {P}_{O\_PUCCH , b , f , c} ( \text{} {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + Δ \text{?} ( F ) + Δ \text{?} ( i ) + {g}_{b , f , c} ( i , l )\end{matrix} \} \qquad Formula ( 2 )$$

$$\text{?} \text{indicates text missing or illegible when filed}$$

Similar to the power control mechanism of the PUSCH, a power control mechanism of a PUCCH also includes two parts: an open-loop power control (P0, PL) and a closed-loop power control (g). Same parameters have the same meanings as those in the PUSCH power control, which are not repeated herein.
qᵤ: denotes an index of a parameter P_{O_PUCCH,b,f,c}(qᵤ);
Δ_{F_PUCCH}(F): denotes a PUCCH power adjustment value related to a PUCCH format;
Δ_{TF,b,f,c}(i): denotes a power compensation factor related to a code rate;
g_{b,f,c}(i, l): denotes an adjustment state of a closed-loop power control of a PUCCH.

A value of a path loss compensation factor of the PUCCH is 1.

If a terminal device is configured with spatial information (e.g., beam information), an open-loop power control parameter and a closed-loop power control parameter of the PUCCH may be determined through spatial relationship information according to a mapping relationship between spatial information configured by an RRC signaling and a power control parameter.

### 3. SRS Power Control

A transmission power of an SRS can be expressed by the following formula (3):

$${P}_{SRS , b , f , c} ( i , {q}_{s} , l ) = min \{ \begin{matrix}{P}_{CMAX , f , c} ( i ) , \\ {P}_{O \_SRS , b , f , c} ( \text{} {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \} \qquad Formula ( 3 )$$

Similar to the power control mechanism of the PUSCH, a power control mechanism of an SRS also includes two parts: an open-loop power control (P0, PL) and a closed-loop power control (h). The same parameters have the same meanings as those in PUSCH power control, which will not be repeated herein.
qₛ: denotes an index of an SRS resource set;
h_{b,f,c}(i, l): denotes an adjustment state of a closed-loop power control of an SRS.

A power control of the SRS is performed based on an SRS resource set, and an SRS resource in the SRS resource set uses a same power control parameter.

The SRS resource set indexes of the open-loop power control parameter P_{O_SRS,b,f,c}(As) and α_{SRS,b,f,c}(qₛ) as well as a reference signal index used to calculate a path loss PL_{b,f,c}(q_{d}) are all configured based on the SRS resource set and configured by an RRC signaling.

h_{b,f,c}(i, l): may be indicated by an RRC signaling to be associated with the closest PUSCH in time domain to use a same closed-loop power adjustment state, or use an independent closed-loop power control adjustment state.

To facilitate the understanding of the technical solution of the embodiments of the present disclosure, a power headroom report (PHR) related to the present disclosure will be described.

In some embodiments, a Type1 PHR or Type 3 PHR may be reported, for example, a terminal device reports the PHR carried by the PUSCH to the network device.

### 1. Type1 PHR

Type1 PHR is used to report a power headroom of a terminal device for transmitting a

PUSCH. Type1 PHR may include: a PHR based on an actually transmitted PUSCH and a PHR based on reference PUSCH.

The PHR based on the actually transmitted PUSCH is a difference between a maximum transmission power of the terminal device and the actually transmitted PUSCH power. For example, the PHR based on the actually transmitted PUSCH can be calculated by the following formula (4):

$$PH \text{?} ( i , j , q \text{?} , l ) = {P}_{CMAX , f , c} ( i ) - \{ {P}_{O \_SRS , b , f , c} ( j ) + 10 {log}_{10} ( 2 \text{?} \cdot {M}^{PUSCH} \text{?} ( i ) ) + α \text{?} ( j ) \cdot PL \text{?} ( q \text{?} ) + Δ \text{?} ( i ) + f \text{?} ( i , l ) \} \qquad Formula ( 4 )$$

$$\text{?} \text{indicates text missing or illegible when filed}$$

A unit of PH is dB. The meanings of various parameters in the formula (4) refer to a description of the same parameter in the power control mechanism of PUSCH, which will not be repeated herein.

A PHR based on a reference PUSCH is a difference between a maximum transmission power of a terminal device and a reference PUSCH power. It can be understood that no PUSCH is transmitted on the carrier at the time of calculating the PHR, for example, which can be calculated using the following formula (5):

$$PH \text{?} ( i , j , {q}_{d} , l ) = {\tilde{P}}_{CMAX} \text{?} ( i ) - \{ {P}_{0 \_ PUSCH} \text{?} ( j ) + {α}_{b , f , c} ( j ) \cdot {PL}_{b , f , c} ( {q}_{d} ) + {f}_{b , f , c} ( i , l ) \} \qquad Formula ( 5 )$$

$$\text{?} \text{indicates text missing or illegible when filed}$$

A unit of PH is dB, \tilde{P}_{CMAX,f,c}(i) denoting a maximum transmission power determined based on a specific parameter value. The meanings of various parameters in the formula (5) refer to a description of the same parameter in the power control mechanism of PUSCH, which will not be repeated herein.

### 2. Type3 PHR

A Type3 PHR is used to report a power headroom of a terminal device for transmitting an SRS, and the Type3 PHR is only reported for a carrier that are not configured with the PUSCH. Type3 PHR includes: a PHR based on an actually transmitted SRS and a PHR based on a reference SRS.

The PHR based on the actually transmitted SRS is a difference between a maximum transmission power of a terminal device and the actually transmitted SRS power. For example, the PHR based on the actually transmitted SRS can be calculated by using the following formula (6):

$$PH \text{?} ( i , q \text{?} ) = {P}_{CMAX} \text{?} ( i ) - \{ {P}_{O\_SRS} \text{?} ( q \text{?} ) + 10 {log}_{10} ( 2 \text{?} \cdot {M}_{SRS} \text{?} ( i ) ) {α}_{SRS} \text{?} ( q \text{?} ) \cdot PL \text{?} ( q \text{?} ) + h \text{?} ( i ) \} \qquad Formula ( 6 )$$

$$\text{?} \text{indicates text missing or illegible when filed}$$

A unit of PH is dB. The meanings of various parameters in the formula (6) refer to a description of the same parameter in the power control mechanism of SRS, which will not be repeated herein.

A PHR based on a reference SRS is a difference between a maximum transmission power of a terminal device and a reference SRS power. It can be understood that no SRS is transmitted on the carrier at the time of calculating the PHR. For example, the PHR based on a reference SRS can be calculated by using the following formula:

$$PH \text{?} ( i , q \text{?} ) = {\tilde{P}}_{CMAX} \text{?} ( i ) - \{ {P}_{O\_SRS} \text{?} ( q \text{?} ) + {α}_{SRS} \text{?} ( q \text{?} ) \cdot PL \text{?} ( q \text{?} ) + h \text{?} ( i ) \} \qquad Formula ( 7 )$$

$$\text{?} \text{indicates text missing or illegible when filed}$$

A unit of PH is dB, \tilde{P}_{CMAX,f,c}(i) denotes a maximum transmission power determined based on a specific parameter value. The meanings of various parameters in the formula (7) refer to a description of the same parameter in the power control mechanism of SRS, which will not be repeated herein.

To facilitate the understanding of the technical solutions of the embodiments of the present disclosure, an antenna panel related to the present disclosure will be described.

With the continuous evolution of an antenna packaging technology, a plurality of antenna elements may be nested and combined with a chip to form a panel, which makes it possible to configure a plurality of panels with low-correlation in a transmitter. Through a beamforming technology of multi-antenna, transmission signal energy is concentrated in a certain direction for transmission, which may effectively improve coverage, thereby improving the performance of the communication. Radio frequency links of a plurality of panels are independent, each panel of a plurality of panels may independently form a transmission beam, and beams formed by different panels may be the same or different. Therefore, a terminal transmitter may send a data stream on a plurality of panels simultaneously through different beams, so as to improve the capacity or reliability of the transmission.

The terminal device needs to notify the network side of a number of the configured antenna panels in a capability report. At the same time, the terminal device may also need to notify the network side whether the terminal device has an ability to transmit a signal on a plurality of antenna panels simultaneously. Since channel conditions corresponding to different panels are different, different panels need to adopt different transmission parameters according to respective channel information. In order to obtain these transmission parameters, different sounding reference signal resources (SRS Resources) need to be configured for different panels, so as to obtain uplink channel information. For example, in order to perform beam management of uplink, an SRS resource set may be configured for each panel, so that each panel performs beam management separately and determines an independent analog beam. In order to obtain precoding information used by physical uplink shared channel (PUSCH) transmission, an SRS resource set may also be configured for each panel, and the SRS resource set is used to obtain a transmission parameter, such as a beam, a precoding vector, and a number of transmission layers, etc., used by the PUSCH transmitted on the panel. At the same time, the multi-panel transmission may also be applied to physical uplink control channel (PUCCH), that is, information carried by a PUCCH resource or PUCCH resources on a same time domain resource may be sent to the network side by different panels simultaneously. Herein, each panel may have its own panel ID, which is used to associate different signals transmitted on a same panel, that is, the terminal device may consider that signals associated with a same panel ID need to be transmitted from a same panel.

In order to facilitate the understanding of the technical solutions of the embodiments of the present disclosure, an uplink non-coherent transmission related to the present disclosure is described.

In the NR system, a downlink and uplink non-coherent transmission based on a plurality of transmission reception points (TRP) is introduced. Herein, a backhaul connection between TRPs may be ideal or non-ideal. Information may be exchanged quickly and dynamically between TRPs under ideal backhaul, and information may be exchanged just quasi-statically between TRPs under non-ideal backhaul due to large latency. In a downlink non-coherent transmission, a plurality of TRPs may independently schedule a plurality of physical downlink shared channel (PDSCH) transmissions of a terminal device based on different control channels, or may also schedule transmissions of different TRPs based on a same control channel, where data of different TRPs is based on different transport layers, and the latter can only be used in the case of the ideal backhaul.

In an uplink non-coherent transmission, different TRPs may also independently schedule PUSCH transmissions of a same terminal device. Different PUSCH transmissions may be configured with independent transmission parameters, such as a beam, a precoding matrix, a number of layers, etc. The scheduled PUSCH transmission may be transmitted on a same slot or on different slots. If the terminal device is scheduled with two PUSCH transmissions at a same slot simultaneously, the terminal device needs to determine how to perform the transmission based on its own capability. If the terminal device is configured with a plurality of panels and supports simultaneous transmission of PUSCHs on the plurality of panels, the terminal device may transmit the two PUSCHs simultaneously, and the PUSCHs transmitted on different panels are aligned to the respective TRPs for analog forming, thereby distinguishing different PUSCHs by spatial domain, and improving spectrum efficiency of the uplink (as shown in FIG. 2). If the terminal device only has a single panel, or does not support the simultaneous transmission of a plurality of panels, the terminal device can transmit PUSCHs only on one panel. Similar to downlink, PUSCHs transmitted by different TRPs may be scheduled based on a plurality of downlink control information (DCI), and these DCI may be carried by different control resource sets (CORESETs). For example, a plurality of CORESET groups are configured at the network side, and each TRP schedules based on a CORESET in the respective CORESET group, that is, different TRPs may be distinguished by CORESET groups. For example, a network device can configure a CORESET group index for each CORESET, and different indexes indicate that different CORESET groups correspond to different TRPs. Similarly, PUSCHs transmitted to different TRPs may be scheduled based on single DCI, and at this time, beams and demodulation reference signal (DMRS) ports on which PUSCH transport layers transmitted to different TRPs are based respectively, need to be indicated in the DCI (as shown in FIG. 3), that is, a transport layer with a different PUSCH may be transmitted on a different panel.

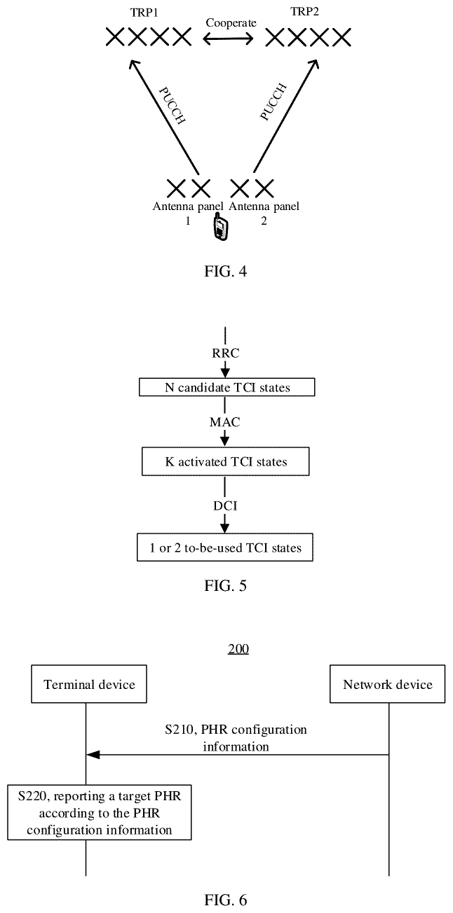

A similar method may also be used for a PUCCH transmission. That is, the terminal device may configure that different PUCCHs are transmitted on different panels simultaneously, and different beams are based on the different panels, which are notified to the terminal device through respective spatial relation information. Taking two different PUCCHs being transmitted on different panels as an example, as shown in FIG. 4, the PUCCHs transmitted on the different panels may be used to carry uplink control information (UCI) sent to different TRPs, for example, UCI on a panel 1 is sent to a TRP1, and UCI on a panel 2 is sent to a TRP2.

In order to facilitate the understanding of the technical solutions of the embodiments of the present disclosure, the uplink beam management related to the present disclosure is described.

In the NR system, the terminal device may use an analog beam to transmit uplink data and uplink control information. The terminal device may perform uplink beam management based on an SRS signal, so as to determine an analog beam used by an uplink transmission. For example, the network device may configure an SRS resource set 1 for the terminal device, and the SRS resource set 1 includes N SRS resources (where N>1). The terminal device may use different beams to transmit the N SRS resources, and the network side measures the reception quality of the N SRS resources respectively, and selects K SRS resources with the best reception quality among the N SRS resources. The network side may configure an SRS resource set 2 again, which includes K SRS resources, and instructs the terminal to transmit SRS resources in the SRS resource set 2 by using an analog beam used by the K SRS resources selected among the SRS resource set 1. This may be implemented by configuring the K SRS resources selected among the SRS resource set 1 as reference SRS resources of K SRS resources in the SRS resource set 2 respectively. At this time, based on SRSs transmitted by the terminal device in the SRS resource set 2, the network side may select an SRS resource with the best reception quality and notify the terminal device of a corresponding SRS resource indicator (SRI). The terminal device, after receiving the SRI, determines an analog beam used by an SRS resource indicated by the SRI as an analog beam used by transmitting the PUSCH.

In order to determine a beam used by a PUCCH transmission, in the NR system, a manner of radio resource control (RRC) plus media access control (MAC) signaling is used to indicate a beam used by transmitting UCI on each PUCCH resource. For example, spatial relation information of N PUCCHs (PUCCH-spatialrelationinfo) is first configured by a high-layer signaling, and then, spatial relation information corresponding to each PUCCH resource is determined from the N PUCCH-spatialrelationinfo through a MAC signaling.

In order to facilitate a better understanding of the embodiments of the present disclosure, a transmission configuration indicator (TCI) state of a downlink signal transmission related to the present disclosure is described.

In the NR system, the network device may configure a corresponding transmission configuration indicator (TCI) state for each downlink signal or each downlink channel, so as to indicate a quasi-co-located (QCL) reference signal corresponding to a target downlink signal or a target downlink channel, so that the terminal performs a reception of the target downlink signal or the target downlink channel based on the reference signal.

Herein, a TCI state may include the following configuration:
a TCI state ID, used to identify a TCI state;
QCL information 1;
QCL Information2.

Herein, a piece of QCL information also includes the following information:
QCL type configuration, which may be one of QCL type A, QCL type B, QCL type C, and QCL type D;
QCL reference signal configuration, including a cell ID where the reference signal is located, a bandwidth part (BWP) ID, and an identity of the reference signal (which may be a channel state information reference signal (CSI-RS) resource ID or synchronization signal block (SSB) index).

Herein, the QCL type of at least one QCL information of the QCL information 1 and the QCL information 2 must be one of QCL type A, QCL type B, and QCL type C, and the QCL type of another QCL information (if configured) must be QCL type D.

Herein, definitions of different QCL type configuration are as follows:
‘QCL-Type A’: {Doppler shift, Doppler spread, average delay, delay spread};
‘QCL-Type B’: {Doppler shift, Doppler spread};
‘QCL-Type C’: {Doppler shift, average delay};
‘QCL-Type D’: {Spatial Rx parameter}.

If the network device configures a QCL reference signal of a target downlink channel as a reference SSB or a reference CSI-RS resource through a TCI state, and the QCL type configuration is QCL type A, QCL type B, or QCL type C, the terminal device may assume that a target large-scale parameter of the target downlink channel is same as that of the reference SSB or the reference CSI-RS resource, and thus, use a same corresponding reception parameter for reception, and the target large-scale parameter is determined through the QCL type configuration. Similarly, if the network device configures a QCL reference signal of a target downlink channel as a reference SSB or a reference CSI-RS resource through a TCI state, and the QCL type configuration is QCL type D, the terminal device may receive the target downlink channel by using a same receiving beam (i.e., Spatial Rx parameter) as that for receiving the reference SSB or the reference CSI-RS resource. Generally, the target downlink channel, and reference time synchronization/broadcast channel (SSB/PBCH) or reference CSI-RS resource thereof are transmitted by a same TRP or a same antenna panel or a same beam at the network side. If transmission TRPs or transmission panels or transmission beams of two downlink signals or downlink channels are different, different TCI states are usually configured.

For a downlink control channel, a TCI state may be indicated in a manner of a radio resource control (RRC) signaling or a combination of an RRC signaling and a MAC signaling. For a downlink data channel, an available TCI state set is indicated by an RRC signaling, and a part of TCI states of the TCI state set are activated by a media access control (MAC) layer signaling, and finally, one or two TCI states are indicated from the activated TCI states through a TCI state indication field in the DCI, and then used for a PDSCH scheduled by the DCI. For example, as shown in FIG. 5, the network device indicates N candidate TCI states through an RRC signaling, and activates K TCI states through a MAC signaling, and finally, indicates one or two to-be-used TCI states from the activated TCI states through the TCI state indication field in the DCI.

A PHR reported by a terminal device may be used to assist the network device to configure a parameter related to a power control. However, a frequent reporting of PHR by the terminal device will increase a signaling overhead. Therefore, how to report the PHR to reduce the signaling overhead is an urgent problem to be solved. Furthermore, in some scenarios, PUSCH, PUCCH, and SRS may be transmitted based on spatial information (e.g., panel, TCI state, etc.). In this case, how to report a PHR is also an urgent problem to be solved.

In order to facilitate the understanding of the technical solutions of the embodiments of the present disclosure, the technical solutions of the present disclosure are described in detail below through specific embodiments. The following related technologies may be arbitrarily combined with the technical solutions of the embodiments of the present disclosure as optional solutions, which all fall within the protection scope of the embodiments of the present disclosure. The embodiments of the present disclosure include at least part of the following contents.

FIG. 6 is a schematic interactive diagram of a wireless communication method 200 according to the embodiments of the present disclosure. As shown in FIG. 6, the method 200 includes the following contents:
S210: transmitting, by a network device, PHR configuration information;
correspondingly, receiving, by the terminal device, the PHR configuration information;
S220, reporting, by the terminal device, a target PHR according to the PHR configuration information.

In some embodiments, the target PHR is a PHR determined according to first uplink information, where the first uplink information is associated with spatial information.

In other embodiments, the target PHR is a PHR determined according to a plurality pieces of uplink information, where the plurality pieces of uplink information are associated with a plurality pieces of spatial information and the plurality pieces of uplink information are transmitted simultaneously.

That is, the target PHR may be used to report a PH of the first uplink information associated with the spatial information, or a PH of a plurality pieces of uplink information associated with a plurality pieces of spatial information transmitted simultaneously.

It should be understood that in the embodiments of the present disclosure, the first uplink information may be any uplink information, for example, the first uplink information may be one of the following: PUSCH, PUCCH, SRS.

Similarly, each uplink information of the plurality pieces of uplink information may include one of the following: PUSCH, PUCCH, SRS.

For example, the plurality pieces of uplink information includes a plurality of PUSCHs, or a plurality of PUCCHs, or a plurality of SRSs, or may also include a combination of at least two of a PUSCH, a PUCCH, and an SRS.

It should be understood that in the embodiments of the present disclosure, spatial information may refer to as a spatial configuration (spatial setting) or a spatial relation (Spatial relation) used for transmitting uplink information, for example, including but not limited to at least one of the following: antenna panel information, CORESET group information, reference signal set information, TCI state information, beam information.

In some embodiments, one antenna panel group corresponds to an identity (ID) or an index of the antenna panel group, and different antenna panel groups correspond to different IDs or indexes.

In some embodiments, one antenna panel group may include one or more antenna panels.

In some embodiments, antenna panels in a same antenna panel group may correspond to a same beam, and antenna panels in different antenna panel groups may correspond to different beams.

In some embodiments, antenna panel information may include an ID (i.e., panel ID) or an index of an antenna panel, or may also include an ID or an index of an antenna panel group. That is, uplink information may be associated with one antenna panel, or may be associated with an antenna panel group.

In some embodiments, CORESET group information may include an ID or an index of a CORESET group.

In some embodiments, reference signal set information may include an ID or an index of a reference signal set.

In some embodiments, TCI state information may include a TCI indication.

In some embodiments, beam information may include an ID or an index of a beam, or an ID or an index of a beam group. That is, uplink information may be associated with a beam, or may be associated with a beam group.

In some embodiments, the reference signal set may be a synchronization signal block (SSB) set or a channel state information reference signal (CSI-RS) set or an SRS set.

In the embodiments of the present disclosure, a beam may also be referred to as a spatial domain transmission filter (Spatial domain transmission filter or Spatial domain filter for transmission), or a spatial domain reception filter (Spatial domain reception filter or Spatial domain filter for reception) or a spatial reception parameter (Spatial Rx parameter).

In some embodiments, an association of a plurality pieces of uplink information and a plurality pieces of spatial information may be an one-to-one association of a plurality pieces of uplink information and a plurality pieces of spatial information, where each uplink information is associated with one spatial information, for example, each uplink information is transmitted via associated spatial information.

In some embodiments, a plurality pieces of uplink information is transmitted simultaneously, which may represent that time domain resources of the plurality pieces of uplink information overlap. For example, the plurality pieces of uplink information are transmitted in a same time unit, and the plurality pieces of uplink information overlap in a time domain resource of the time unit. Optionally, the time unit may be one or more slots, one or more sub-slots, one or more subframes, or one or more half frames, or one or more orthogonal frequency-division multiplexing (OFDM) symbols, etc. The present disclosure is not limited thereto.

In some embodiments, a time unit may include continuous time domain resources, for example, the time unit includes N consecutive symbols, where N is a positive integer greater than 1, for example, N is 2, 3 or 4, etc., or, the time unit may also include M consecutive slots, where M is a positive integer greater than 1, for example, M is 2, 3 or 4, etc.

In other embodiments, the time unit may also include discrete time domain resources. For example, the discrete time domain resources can be discrete P symbols within a slot, or discrete Q subframes within a half frame, etc., where P and Q are positive integers greater than 1, for example, P is 2, 3 or 4, etc., and Q is 2, 3 or 4, etc.

Optionally, in some embodiments, when a plurality pieces of uplink information are transmitted in a same time unit, no matter whether the time domain resources occupied by the plurality pieces of uplink information overlap, the plurality pieces of uplink information may be considered to be transmitted simultaneously. That is, as long as time domain resources of the plurality pieces of uplink information are in a same time unit, it can be considered that the plurality pieces of uplink information are transmitted simultaneously.

In some embodiments, a plurality pieces of uplink information is a plurality of PUSCHs associated with a plurality pieces of spatial information, and the plurality of PUSCHs are transmitted simultaneously.

Optionally, the plurality of PUSCHs may be scheduled by a plurality of DCIs, and the plurality of DCIs are used to schedule the plurality of PUSCHs to be transmitted simultaneously in a same time unit.

In some embodiments of the present disclosure, an association between uplink information and spatial information may include but is not limited to at least one of the following:
uplink information being associated with antenna panel information;
the uplink information being associated with CORESET group information;
the uplink information being associated with reference signal set information;
the uplink information being associated with TCI state information;
the uplink information being associated with beam information.

In some embodiments, an association between uplink information and antenna panel information may include: the uplink information being transmitted through an antenna panel corresponding to the antenna panel information.

In some embodiments, an association between uplink information and the CORESET group information may include: a CORESET group corresponding to CORESET group information is the CORESET group to which CORESET where the PDCCH triggering uplink information is located belongs, or can also be that the CORESET group corresponding to the CORESET group information is the CORESET group configured by a higher-layer signaling for transmitting a resource of the uplink information.

In some embodiments, an association between uplink information and reference signal set information may include:

a reference signal set corresponding to the reference signal set information being a reference signal set associated with an antenna panel used to transmit uplink information, or a reference signal set configured by a network device for the uplink information, or a reference signal set associated with a PDCCH or a PDSCH corresponding to the uplink information. Optionally, the PDCCH corresponding to the uplink information may refer to as a PDCCH that schedules the uplink information, and the PDSCH corresponding to the uplink information may refer to as that hybrid automatic repeat request acknowledgement (HARQ-ACK) information carried by the uplink information is the HARQ-ACK information of the PDSCH.

In some embodiments, an association between the uplink information and the TCI state information may include a transmitting beam of the uplink information being determined according to the TCI state information.

In some embodiments, an association between the uplink information and the beam information may include the uplink information being transmitted through a beam corresponding to the beam information.

In some embodiments, a type of a PH included in a target PHR may be type 1 (Type 1), type 2 (Type 2) or type 3 (Type 3), where the PH of Type 1 may be determined according to a power of PUSCH, the PH of Type 2 may be determined according to the power of PUCCH, and the PH of Type 3 may be determined according to the power of SRS.

In some embodiments of the present disclosure, the target PHR may be carried through a media access control control element (MAC CE).

In the embodiments of the present disclosure, PHR configuration information may be a configuration related to a reporting of a PHR, such as periodic information for reporting a PHR, a condition for reporting a PHR, a cell type of a reported PHR, etc., but the present disclosure is not limited thereto.

In some embodiments, the PHR configuration information may be used to configure a reporting condition of a PHR. Therefore, a terminal device reports the PHR according to the PHR configuration information, which is conducive to avoiding a frequent reporting of the PHR and reducing signaling overhead.

In some embodiments of the present disclosure, PHR configuration information is associated with spatial information, or, the PHR configuration information may be configured based on the spatial information, and the PHR configuration information is of a granularity of the spatial information.

For example, corresponding PHR configuration information is configured for different spatial information. For example, when it is necessary to report a PHR corresponding to first uplink information (where the first uplink information is associated with the first spatial information), a terminal device may report the PHR according to PHR configuration information associated with the first spatial information.

In some embodiments, the PHR configuration information includes but not limited to at least one of the following high-layer parameters:
a periodic timer of a PHR (phr-PeriodicTimer);
a timer for prohibiting a PHR from reporting (phr-ProhibitTimer);
a transmission power factor change or a path loss change (phr-Tx-PowerFactorChange);
a PHR mode of an another cell group in a dual connectivity (phr-ModeOtherCG);
a cell type of a reported PHR, where the cell type of the reported PHR is a multi-cell PHR (Multiple Entry PHR) or a single-cell PHR (Single Entry PHR);
a reporting permission of a maximum permissible exposure (MPE) (mpe-Reporting-FR2);
a power management maximum power reduction (P-MPR) threshold (mpe-Threshold);
a timer for prohibiting an MPE from reporting (mpe-ProhibitTimer).

In some embodiments, PHR configuration information associated with each spatial information may include one or more configurations of the above high-layer parameters.

In some embodiments, the high-layer parameters included in the PHR configuration information associated with different spatial information may be the same, or may be different.

In some embodiments, configurations corresponding to a same high-layer parameter included in the PHR configuration information associated with different spatial information may be the same, or may be different.

In some embodiments, the PHR configuration information includes first PHR configuration information and second PHR configuration information, where the first PHR configuration information is associated with first spatial information, the second PHR configuration information is associated with second spatial information, high-layer parameters included in the first PHR configuration information and the second PHR configuration are different, and/or configurations corresponding to a same high-layer parameter included in the first PHR configuration information and the second PHR configuration information are different. That is, a network device may configure different high-layer parameters for different spatial information, and/or indicate different configurations for the same high-layer parameters, that is, the same high-layer parameters may have different values.

In some embodiments, the first PHR configuration information includes but not limited to at least one of the following high-layer parameters:
a reporting permission of a first MPE, a first P-MPR threshold, and a first timer for prohibiting the MPE from reporting.

In some embodiments, the second PHR configuration information includes but not limited to at least one of the following high-layer parameters:
a reporting permission of a second MPE, a second P-MPR threshold, and a second timer for prohibiting the MPE from reporting.

In some embodiments, configurations corresponding to the reporting permission of the first MPE and the reporting permission of the second MPE are different.

In some embodiments, the first P-MPR threshold is different from the second P-MPR threshold.

In some embodiments, the configurations corresponding to the first timer for prohibiting the MPE from reporting and the timer for prohibiting the second MPE from reporting are different.

In some embodiments, the first PHR configuration information being associated the first spatial information includes at least one of the following:
the first PHR configuration information being associated with first antenna panel information;
the first PHR configuration information being associated with first CORESET group information;
the first PHR configuration information being associated with first reference signal set information;
the first PHR configuration information being associated with first TCI state information;
the first PHR configuration information being associated with first beam information.

In some embodiments, the second PHR configuration information being associated the second spatial information includes at least one of the following:
the second PHR configuration information being associated with second antenna panel information;
the second PHR configuration information being associated with second CORESET group information;
the second PHR configuration information being associated with second reference signal set information;
the second PHR configuration information being associated with second TCI state information;
the second PHR configuration information being associated with second beam information.

That is, the network device can configure different PHR configuration information for different antenna panels, or configure different PHR configuration information for different CORESET groups, or configure different PHR configuration information for different reference signal sets, or configure different PHR configuration information for different TCI states, or configure different PHR configuration information for different beams.

Therefore, in the embodiments of the present disclosure, for different spatial information, the network device may associate different combinations of high-layer parameters, and/or configurations of associated high-layer parameters are different, thereby achieving the PHR reporting of spatial information granularity.

In some embodiments, first spatial information may be spatial information indexed as x, and second spatial information may be spatial information indexed as y, where x and y are integers, and a range of x and y is [0, N−1], and N is a total number of spatial information supported by a terminal device, and x and y are not the same.

In some embodiments, N is predefined or determined according to a capacity of a terminal device. For example, the terminal device may report the maximum number of spatial information supported by the terminal device to a network device, and the network device determines N based on the maximum number of spatial information reported by the terminal device.

In some embodiments, N may be an integer multiple of 2, such as 2, 4, 6, 8, etc.

In some embodiments, a periodic timer of the PHR is used to control a period or a frequency of a PHR reporting. For example, after the periodic timer of the PHR expires, the PHR is triggered to be reported by a terminal device. Configuring a periodic timer of a PHR is beneficial to avoid the PHR being reported frequently by a terminal device.

Taking PHR configuration information being associated with a panel ID as an example, for different panel IDs, time of phr-PeriodicTimer configured by a network device may be different. For example, for a panel ID of 0, the associated phr-PeriodicTimer is configured as 10 subframes, and for the panel ID of 1, the associated phr-PeriodicTimer is configured as 20 subframes. When the phr-PeriodicTimer associated with different panels expires, the terminal device is triggered to report the PHR of uplink information associated with the panel.

In some embodiments, a timer for prohibiting the PHR from reporting is used to control a period or frequency of PHR reporting. For example, after the timer prohibiting the PHR from reporting expires, the terminal device is triggered to report the PHR. Configuring a periodic timer for prohibiting the PHR from reporting is beneficial to avoid reporting the PHR frequently by the terminal device.

Taking the PHR configuration information being associated with the panel ID as an example, for different panel IDs, the time of the timer for prohibiting the PHR from reporting may be different. For example, for a panel ID of 0, an associated phr-ProhibitTimer is configured as 20 subframes, and for a panel ID of 1, the associated phr-ProhibitTimer is configured as 50 subframes. When the phr-ProhibitTimer associated with different panels expires, the terminal device is triggered to report the PHR of the uplink information associated with the panel.

In some embodiments, a transmission power factor change or a path loss change is characterized by a number of a decibel (dB), which may be used to indicate a reporting condition of the PHR to avoid reporting the PHR frequently by the terminal device. For example, when the transmission power factor change or the path loss change exceeds the configured number of the decibel, the terminal device triggers reporting of the PHR.

Taking PHR configuration information being associated with a panel ID as an example, for different panel IDs, a transmission power factor change or a path loss change can be configured as different number of decibels. Then, for PHR reporting of uplink information on different panels, when the path loss change measured by the terminal device exceeds number of decibels configured by the associated phr-Tx-PowerFactorChange, the terminal device is triggered to report the PHR.

In some embodiments, a PHR mode of another cell group in dual connectivity includes a PHR based on an actual transmission (i.e., actual PHR, represented by real) and a PHR based on a reference transmission (i.e., virtual PHR, represented by virtual).

In some embodiments, when a terminal device is in dual connectivity (DC), and the terminal device reports a PHR through a cell group, the network device may configure a PHR mode for another cell group, and the terminal device reports the PHR of the another cell group according to the PHR mode.

Taking PHR configuration information being associated with a panel ID as an example, for different panel IDs, a network device can configure the high-layer parameter phr-ModeOtherCG as different modes. For example, for a panel ID of 0, phr-ModeOtherCG is configured as “real”, and for a panel ID of 1, phr-ModeOtherCG is configured as “virtual”. For a PHR reporting of uplink information associated with different panels, the PHR reporting may be performed based on the configured modes.

In some embodiments, a cell type of a reported PHR is used by a network device to indicate whether the PHR reported by the terminal device is a multi-cell PHR or a single-cell PHR.

Optionally, the single-cell PHR may refer to as a PHR corresponding to the single cell, and the PHR corresponding to the single cell may be determined according to the uplink information transmitted on the single cell. For example, it is determined according to a PUSCH, SRS or PUCCH transmitted on the single cell.

Optionally, a multi-cell PHR may include a PHR corresponding to each cell in the multiple cells, where the PHR corresponding to each cell may be determined according to uplink information transmitted on the cell, and for example, determined according to the PUSCH, SRS or PUCCH transmitted on the cell.

In some embodiments, a reporting permission of an MPE is used to indicate whether the terminal device reports an MPE P-MPR value in the MAC CE carrying a PHR.

Taking PHR configuration information being associated with a panel ID as an example, for different panel IDs, reporting permissions of an MPE may be different configurations. For example, for the panel ID of 0, it indicates that the terminal device needs to report the MPE P-MPR value in the MAC CE carrying PHR. For the panel ID of 1, it indicates that the terminal device does not need to report the MPE P-MPR value in the MAC CE carrying PHR.

In some embodiments, when a P-MPR is greater than or equal to a P-MPR threshold, a terminal device reports an MPE P-MPR value.

Taking PHR configuration information being associated with a panel ID as an example, for different panel IDs, a P-MPR threshold may be configured differently. For example, for a panel ID of 0, the P-MPR threshold is 3 dB, and for the panel ID of 1, the P-MPR threshold is 6 dB.

In some embodiments, a timer for prohibiting an MPE from reporting is used by the network device to indicate a terminal device to prohibit from reporting the MPE timer.

Taking PHR configuration information being associated with a panel ID as an example, for different panel IDs, a timer for prohibiting an MPE from reporting may be configured differently. For example, for a panel ID of 0, a configured mpe-ProhibitTimer is 10 subframes, and for the panel ID of 1, the configured mpe-ProhibitTimer is 20 subframes.

In some embodiments, the PHR configuration information associated with each spatial information configured by the network device is carried in a same information element (IE). For example, the PHR configuration information associated with each spatial information is included in order from small to large according to an index or ID corresponding to the spatial information. Optionally, each PHR configuration information includes a spatial information ID or an index field for the spatial information associated with the PHR configuration information.

In some embodiments, all PHR configuration information associated with the spatial information may be carried in a newly defined IE, or carried in an existing IE, which is not limited thereto in present disclosure.

Taking the spatial information as a panel ID as an example, the PHR configuration information for all panel IDs may be carried in a newly defined IE, for example, a newly defined PHR-Config-r18 IE is used to carry the PHR configuration information for all panels.

As an example but not a limitation, a structure of the PHR-Config-r18 IE is as follows:

| | |
|---|---|
| PHR-Config-r18 ::= | SEQUENCE { |
| panel-ToAddModList | SEQUENCE(SIZE (1...maxNrofpanel-IDs)) OF Panel |

| | |
|---|---|
| panel-ToReleaseList | SEQUENCE(SIZE (1...maxNrofpanel-IDs)) OF Panel-ID |
| panel-ID | Panel-ID |

}

| | |
|---|---|
| Panel::= | SEQUENCE { |

panel-ID Panel-ID,

| | |
|---|---|
| phr-PeriodicTimer | ENUMERATED {sf10, sf20, sf50, sf100, sf200,sf500, |

sf1000, infinity},

| | |
|---|---|
| phr-ProhibitTimer-panel | ENUMERATED {sf0, sf10, sf20, sf50, sf100,sf200, |

sf500, sf1000},

| | |
|---|---|
| phr-Tx-PowerFactorChange | ENUMERATED {dB1, dB3, dB6, infinity}, |
| multiplePHR | BOOLEAN, |
| dummy | BOOLEAN, |
| phr-Type2OtherCell | BOOLEAN, |
| phr-ModeOtherCG | ENUMERATED {real, virtual}, |

```
    ...,
    [[
```

| | |
|---|---|
| mpe-Reporting-FR2-r16 | SetupRelease { MPE-Config-FR2-r16 } |

OPTIONAL -- Need M
]]
}

The maxNrofpanel-IDs identifies a maximum number of panel IDs, corresponding to the aforementioned N.

It can be seen that the PHR configuration information associated with each panel may include a Panel ID associated with the PHR configuration information.

It should be understood that when the PHR configuration information is associated with other spatial information (for example, a beam ID or a CORESET group index), a panel-related parameter in the IE carrying the above PHR configuration information can also be replaced by parameters related to other spatial information, such as a beam ID, a CORESET group index, etc., which is not limited thereto in the present disclosure.

In other embodiments, the PHR configuration information associated with each spatial information is independently carried in an IE.

Taking the spatial information as a panel ID as an example, the PHR configuration information for a panel ID can be carried in a newly defined IE, for example, a newly defined PHR-Config-panel-ID IE is used to carry the PHR configuration information associated with the panel ID.

As an example but not a limitation, a structure of the PHR-Config-panel-ID IE is as follows:

| | |
|---|---|
| PHR-Config-panel-ID ::= | SEQUENCE { |
| phr-PeriodicTimer | ENUMERATED {sf10, sf20, sf50, sf100, sf200,sf500, |

sf1000, infinity},

| | |
|---|---|
| phr-ProhibitTimer-panel | ENUMERATED {sf0, sf10, sf20, sf50, sf100,sf200, |

sf500, sf1000},

| | |
|---|---|
| phr-Tx-PowerFactorChange | ENUMERATED {dB1, dB3, dB6, infinity}, |
| multiplePHR | BOOLEAN, |
| dummy | BOOLEAN, |
| phr-Type2OtherCell | BOOLEAN, |
| phr-ModeOtherCG | ENUMERATED {real, virtual}, |

```
    ...,
    [[
```

| | |
|---|---|
| mpe-Reporting-FR2-r16 | SetupRelease { MPE-Config-FR2-r16 } |

```
OPTIONAL -- Need M
    ]]
  }
```

| | |
|---|---|
| MPE-Config-FR2-r16 ::= | SEQUENCE { |
| mpe-ProhibitTimer-r16 | ENUMERATED {sf0, sf10, sf20, sf50, sf100, sf200, |

sf500, sf1000},

| | |
|---|---|
| mpe-Threshold-r16 | ENUMERATED {dB3, dB6, dB9, dB12} |

}

It should be understood that when the PHR configuration information is configured based on other spatial information (for example, a beam ID or a CORESET group index), a panel-related parameter in the IE carrying the above PHR configuration information can be replaced by parameters of other spatial information, for example, a parameter associated with a beam ID, a parameter associated with the CORESET group index, etc., which is not limited thereto in the present disclosure.

In some embodiments of the present disclosure, the method 200 further includes:
determining, by the terminal device according to the PHR configuration information, whether a PHR triggering condition is satisfied;
determining, by the terminal device, to report the target PHR upon the PHR triggering condition is satisfied.

In some embodiments, the terminal device can determine whether the PHR reporting condition is satisfied according to the phr-PeriodicTimer or phr-ProhibitTimer associated with the spatial information.

For example, when the phr-PeriodicTimer or the phr-ProhibitTimer expires, it is determined that the PHR reporting condition is satisfied.

Optionally, a timer starting condition of the phr-PeriodicTimer or the phr-ProhibitTimer may be that the PHR configuration information is received.

In some embodiments, a terminal device may determine whether the PHR reporting condition is satisfied according to a transmission power factor change or a path loss change associated with the spatial information.

For example, when the path loss change measured by the terminal device exceeds number of decibels configured by the associated phr-Tx-PowerFactorChange, it is determined that the PHR reporting condition is satisfied.

In some embodiments, the terminal device may determine whether the PHR reporting condition is satisfied according to at least two high-layer parameters in the PHR configuration information.

For example, the at least two high-layer parameters may be phr-PeriodicTimer and a transmission power factor change or a path loss change, and the at least two high-layer parameters are associated with same spatial information. As an example, when the phr-PeriodicTimer expires and the path loss change measured by the terminal device exceeds the number of decibels configured by the associated phr-Tx-PowerFactorChange, it is determined that the PHR reporting condition is satisfied.

In some embodiments of the present disclosure, a target PHR may be carried through a MAC CE.

The following describes a structural design of the MAC CE that carries the PHR in conjunction with Embodiment 1.

For example, both a single-cell PHR (Single entry PHR) and a multi-cell PHR (Multiple entry PHR) may be carried through a MAC CE.

That is, in the embodiments of the present disclosure, a single-cell PHR or a multi-cell PHR associated with the spatial information may be carried through the MAC CE.

Structures of the MAC CE carrying the single-cell PHR and the multi-cell PHR are described in combination with Embodiment 1-1 and Embodiment 1-2, respectively.

### Embodiment 1-1: Single-Cell PHR (Single Entry PHR)

In some embodiments of the present disclosure, a target PHR includes a first PHR, and the first PHR is a single-cell PHR, and the first PHR is carried through a first MAC CE, and the first PHR is associated with the first spatial information.

In some embodiments, the first PHR is a single-cell PHR.

In some embodiments, the first PHR being associated with the first spatial information may include the first PHR being determined according to uplink information associated with the first spatial information, for example, being determined according to a PUSCH, a PUCCH or an SRS associated with the first spatial information. The association between the first spatial information and the uplink information may refer to the relevant description of the previous embodiments, which is not repeated herein.

In some embodiments, the first PHR being associated with the first spatial information may include at least one of the following:
the first PHR being associated with the first antenna panel information;
the first PHR being associated with first CORESET group information;
the first PHR being associated with first reference signal set information;
the first PHR being associated with first TCI state information;
the first PHR being associated with first beam information.

For example, the first PHR is determined according to the uplink information associated with the first antenna panel information, or determined according to the uplink information associated with the first CORESET group information, or determined according to the uplink information associated with the first reference signal set information, or determined according to the uplink information associated with the first TCI state information, or determined according to the uplink information associated with the first beam information.

In some embodiments, the first PHR is a PHR of a first cell, and the first PHR may be determined according to first uplink information, where the first uplink information is uplink information associated with the first spatial information on the first cell.

In some embodiments, the first PHR may be determined according to a power of the first uplink information actually transmitted, that is, a mode of the first PHR may be an actual PHR mode. Optionally, the first uplink information may be a PUSCH, a PUCCH or an SRS.

It should be understood that in the embodiments of the present disclosure, spatial information associated with the single-cell PHR carried in the first MAC CE can be indicated by explicit indication information or implicit indication information, and the present disclosure does not limit the indication method of the spatial information.

In some embodiments of the present disclosure, one or more bits in the first MAC CE are used to indicate the spatial information associated with the first PHR.

In some embodiments, one or more bits of the first MAC CE are used to indicate one type of spatial information among antenna panel information, CORESET group information, reference signal set information, TCI state information and beam information associated with the first PHR.

In some embodiments, a specific number of bits of the one or more bits may be determined according to the total number of indexes or IDs included in spatial information. For example, if the one or more bits are used to indicate antenna panel information associated with the first PHR, the specific number of the one or more bits can be determined according to the total number of antenna panel information. As an example, if two panel IDs need to be indicated, the two panel IDs can be indicated through 1 bit, or, if more panel IDs need to be indicated, more bits are required, such as 2 bits, 3 bits, etc. For example, if four panel IDs need to be indicated, 2 bits are required.

Optionally, the one or more bits may be reserved bits in the MAC CE, and the spatial information associated with the PHR carried in the MAC CE is indicated to a network device through the reserved bits in the MAC CE, so that the network device can quickly acquire the PH corresponding to the spatial information.

In some cases, for a terminal device that supports reporting a PHR associated with spatial information, such as a terminal device of 3GPP release (R) 18 and later releases, the one or more bits are used to indicate the spatial information associated with the second PHR; for the terminal device that does not support reporting a PHR associated with the spatial information, for example, for the terminal device before R18, the one or more bits are reserved bits.

In other embodiments, the one or more bits of the first MAC CE are used to indicate at least one of antenna panel information, CORESET group information, reference signal set information, TCI state information, and beam information.

For example, the first MAC CE includes at least one bit group, each bit group includes one or more bits, the each bit group corresponds to a type of spatial information, and a value of the each bit group is used to indicate target spatial information associated with the first PHR in a corresponding type of spatial information.

In some embodiments, the at least one bit group corresponds to at least one type of spatial information, and the at least one type of spatial information includes at least one of: antenna panel information, CORESET group information, reference signal set information, TCI state information, beam information.

As an example, a first MAC CE includes L bit groups, corresponding to L types of spatial information respectively, for example, L may be 1, 2 or 3, etc.

Taking L=2 as an example, the L types of spatial information may include the antenna panel information and the CORESET group information. Then, the first MAC CE may include two bit groups, for example, a first bit group and a second bit group, which are respectively used to indicate the antenna panel information and CORESET group information associated with the first PHR.

In some embodiments, a number of bits included in each bit group may be the same or different. For example, the number of bits may be determined according to a total number of indexes or IDs included in each type of spatial information, or the number of bits may also be determined according to a maximum value of the total number of indexes or IDs included in the each type of spatial information.

For example, the number of bits occupied by the first bit group may be determined according to the maximum number of panel IDs, or may also be determined according to the maximum value of the maximum number of indexes or IDs included in the each type of spatial information.

As an example, the total number of panel IDs is 4, the total number of CORESET group indexes is 2, the total number of reference signal set indexes is 2, the total number of TCI indications is 8, and the total number of beam IDs is 16. Then, the number of bits occupied by the first bit group can be determined according to the total number of panel IDs 4, or can be determined according to the total number of beam IDs 16. For example, the first bit group may be 2 bits, or 4 bits.

In some embodiments, for a terminal device that supports reporting a PHR associated with spatial information, such as a terminal device of R18 and later releases, the at least one bit group are used to indicate the spatial information associated with the first PHR; for the terminal device that does not support reporting a PHR associated with the spatial information, for example, for the terminal device before R18, the at least one bit group are reserved bits.

That is, for the terminal device of R18 and later releases, the at least one bit group may be interpreted as spatial information associated with the first PHR, and for the terminal device before R18, the at least one bit group may not be interpreted.

In conjunction with FIG. 7, taking the spatial information as a panel ID as an example, a format of a MAC CE for carrying a PHR provided by the present disclosure will be described.

It should be understood that the number of bits occupied by each information in the MAC CE shown in FIG. 7 and the specific position format are only examples, which can be flexibly adjusted according to the carried specific information size or actual needs, and the present disclosure is not limited thereto.

As shown in FIG. 7, the MAC CE includes 1 bit, which is used to indicate the panel ID. For example, a value of 0 indicates panel ID 0, and a value of 1 indicates panel ID 1. Optionally, when more types of panel IDs need to be indicated, more bits may be included.

Optionally, the MAC CE also includes a type of PH, for example, Type1, Type2 or Type3.

In some embodiments, the MAC CE may also include a target maximum transmission power corresponding to the panel ID.

In some embodiments, the target maximum transmit power corresponding to the panel ID can be the maximum transmission power corresponding to the panel ID, or the maximum transmission power of the terminal device (or the maximum transmission power on carrier f of cell c of the terminal device), or the sum of the maximum transmission powers corresponding to all panel IDs of the terminal device.

Optionally, the maximum transmission power corresponding to the panel ID may refer to as the maximum transmission power that can be used when the panel corresponding to the panel ID is used to send the uplink information. Optionally, the maximum transmission power corresponding to the panel ID is determined according to a capability of the terminal device.

In the MAC CE format of FIG. 7, the target maximum transmission power P_{CMAX,f,c} corresponding to the panel ID is taken as an example, but the present disclosure is not limited thereto, where P_{CMAX,f,c} denotes a maximum transmission power of a terminal device, or a maximum transmission power on a carrier f in the cell c of the terminal device.

In some embodiments, a terminal device may report to a network device whether the maximum transmission power shared by a plurality pieces of uplink information is reported, where the plurality pieces of uplink information are associated with the plurality pieces of spatial information.

Optionally, when the plurality pieces of uplink information shares the maximum transmission power, the target maximum transmission power corresponding to each spatial information may be the maximum transmission power of the terminal device, or a sum of the maximum transmission powers corresponding to all spatial information of the terminal device. Alternatively, in a case where a plurality pieces of uplink information do not share a maximum transmission power, a target maximum transmission power corresponding to each spatial information may be the maximum transmission power corresponding to spatial information.

For example, when a plurality pieces of uplink information are associated with a plurality of panel IDs and in a case that the plurality pieces of uplink information share a maximum transmission power, target maximum transmission power information corresponding to a panel ID included in a MAC CE carrying the single-cell PHR associated with the panel may be the maximum transmission power of the terminal device, or a sum of the maximum transmission powers corresponding to all panel IDs of the terminal device. Alternatively, when a plurality pieces of uplink information do not share a maximum transmission power, target maximum transmission power information corresponding to a panel ID included in a MAC CE carrying a single-cell PHR associated with the panel ID may be the maximum transmission power corresponding to the panel ID.

Optionally, the MAC CE also includes first indication information, which is used to indicate a cell corresponding to a PH in a MAC CE. For example, in this example, the cell corresponding to the first PHR is a primary cell (PCell).

In other embodiments of the present disclosure, a MAC subheader of a first MAC CE is used to indicate spatial information associated with a first PHR. Alternatively, the spatial information associated with the first PHR is identified through a MAC subheader of a first MAC CE.

In some embodiments, a logical channel identity (LCID) in a MAC subheader of a first MAC CE is used to indicate spatial information associated with the first PHR. That is, the spatial information associated with the single-cell PHR in the MAC CE carrying the single-cell PHR is identified through the LCID of the MAC subheader. The MAC CE carrying the single-cell PHR associated with different spatial information is associated through the LCID value of the MAC subheader. In this case, there is no need to modify the structure of the MAC CE.

In some embodiments, there is an association between the LCID and the spatial information. Thus, the terminal device can indicate different spatial information to the network device through different LCIDs.

As an example, a codepoint and/or an index of the LCID in the MAC subheader of the first MAC CE is used to indicate the spatial information associated with the first PHR.

For example, there is an association between the codepoint and/or index of the LCID and the spatial information, so the terminal device can indicate different spatial information to the network device through different codepoints and/or indexes of the LCID.

Taking the spatial information as a panel ID as an example, codepoints and/or indexes of the LCID associated with different panel IDs are different. Therefore, the network device can determine the panel associated with the single-cell PHR in the MAC CE associated with the LCID based on the codepoint and/or the index of the LCID.

Taking the spatial information as the panel ID as an example, in some implementations, a LCID value corresponding to the codepoint and/or the index of the LCID is associated with the single-cell PHR with panel ID x, where x is an integer in the range of [0, N−1], and N is a total number of panels supported by the terminal device.

In some embodiments, the LCID value is an LCID value of an uplink shared channel(s) (UL-SCH).

In some embodiments, the terminal device supports N pieces of antenna panel information, and the N pieces of antenna panel information are associated with code points and/or indexes of N LCID values, where N is a positive integer.

For example, when a number of reserved codepoints and/or indexes with LCID values is greater than N, and reserved codepoints and/or indexes with any N LCID values can be used to associate the single-cell PHR associated with N panel IDs, and the LCID values corresponding to the reserved codepoints and/or indexes with the remaining LCID values are still reserved.

That is, there is an association between reserved codepoints and/or indexes with N LCID values and the single-cell PHRs associated with N panel IDs. For example, there is an one-to-one correspondence between reserved codepoints and/or indexes with N LCID values and N panel IDs. Therefore, a panel associated with a single-cell PHR in an associated MAC CE may be determined according to a LCID value of a MAC subheader.

Thus, in the embodiments of the present disclosure, by associating the LCID in the MAC subheader with the spatial information, the terminal device can set the LCID value in the MAC subheader according to the spatial information associated with the PHR, and indicate the spatial information associated with the PHR carried in the MAC CE associated with the MAC subheader through the LCID value in the MAC subheader.

Correspondingly, after receiving the MAC CE, the network device may determine the target spatial information according to the LCID in the MAC subheader associated with the MAC CE, and further determine that the PHR carried in the MAC CE is associated with the target spatial information.

It should be understood that in the embodiments of the present disclosure, the PHR is carried through the MAC CE, and the PHR is associated with the spatial information, and thus, it can be understood that the MAC CE carrying a PHR is associated with the spatial information.

Taking N as 4 as an example, an association between codepoints and/or indexes and panel IDs may be as shown in Table 1.

TABLE 1

| Codepoint/index | LCID value |
|---|---|
| 35 | Panel ID = 0 Single-Cell PHR |
| 36 | Panel ID = 1 Single-Cell PHR |
| 37 | Panel ID = 2 Single-Cell PHR |
| 38 | Panel ID = 3 Single-Cell PHR |
| 39-44 | reserved |

As shown in Table 1, MAC CEs of the single-cell PHR with any 4 associated panel IDs 0 to 3 among the LCID values corresponding to the codepoints and/or indexes 35-44 can be used. As an example, the LCID values corresponding to codepoints and/or indexes 35-38 correspond to single-cell PHRs with panel IDs 0 to 3, respectively, and the LCID values corresponding to the remaining codepoints and/or indexes are still reserved.

It should be understood that the association between the codepoints and/or indexes and the panel IDs in Table 1 is only an example. As long as different panel IDs are associated with values of different codepoints and/or indexes, the present disclosure does not limit thereto.

In some cases, for the terminal device that supports reporting the PHR associated with spatial information, such as for the terminal device of 3GPP release (R) 18 and later releases, the LCID values corresponding to N codepoints and/or indexes of codepoints and/or indexes 35-44 are associated with the single cell PHR corresponding to N panel IDs; for the terminal device that does not support reporting the PHR associated with the spatial information, such as the terminal device before R18, the LCID values corresponding to codepoints and/or indexes 35-44 are still reserved.

Taking N as 4 as an example, the association between the codepoint and/or index and the panel ID may be as shown in Table 2.

TABLE 2

| Codepoint | Index | LCID value |
|---|---|---|
| 0 | 64 | Panel ID = 0 Single-Cell PHR |
| 1 | 65 | Panel ID = 1 Single-Cell PHR |
| 2 | 66 | Panel ID = 2 Single-Cell PHR |
| 3 | 67 | Panel ID = 3 Single-Cell PHR |
| 4-249 | 68-313 | reserved |

As shown in Table 2, codepoints 0-249 corresponds to indexes 64-313, and any 4 of the corresponding LCID values are associated with a single-cell PHR with panel ID 0˜3. As an example, codepoints 0-3 corresponds to indexes 64-67, and the corresponding LCID values correspond to the MAC CEs of the single-cell PHR with panel ID 0˜3 respectively. The LCID values corresponding to the remaining codepoints or indexes are still reserved.

It should be understood that the association between the codepoints or indexes and the panel IDs in Table 2 is only an example. As long as different panel IDs are associated with different value combinations of codepoints and indexes, the present disclosure does not limit thereto.

In some cases, for the terminal device that supports reporting the PHR associated with spatial information, such as for the terminal device of 3GPP release (R) 18 and later releases, the LCID values corresponding to N groups of codepoints and indexes of the codepoints 0-249 and indexes 64-313 are associated with the single cell PHR corresponding to N panel IDs; for the terminal device that does not support reporting the PHR associated with the spatial information, such as the terminal device before R18, the LCID values corresponding to codepoints 0-249 and indexes 64-313 are still reserved.

### Embodiment 1-2: Multi-Cell PHR (Multiple Entry PHR)

In some embodiments of the present disclosure, the target PHR includes a second PHR, and the second PHR is a multi-cell PHR, and the second PHR is carried through a second MAC CE, and the second PHR is associated with the second spatial information.

In some embodiments, the second PHR is a multi-cell PHR.

That is, in the embodiments of the present disclosure, the multi-cell PHR associated with the spatial information may be carried through the MAC CE.

Optionally, the second spatial information may be any spatial information, or any spatial information actually used by the terminal device.

In some embodiments, the terminal device needs to report a PHR of at least one uplink information, where each uplink information is associated with the spatial information, and the spatial information associated with the at least one uplink information includes the second spatial information, then the target PHR may include a second PHR associated with the second spatial information. Optionally, the at least one uplink information further includes third uplink information, and the third uplink information is associated with spatial information A. The target PHR may further include a third PHR, and the third PHR is a multi-cell PHR associated with spatial information A. Taking the second PHR as an example below, and the specific implementation is also applicable to other multi cell PHRs.

In some embodiments, the second PHR being associated with the second spatial information may include the second PHR being determined according to uplink information associated with the second spatial information, for example, being determined according to =PUSCH, PUCCH or SRS associated with the second spatial information. Herein, the association between the second spatial information and the uplink information may refer to the relevant description of the previous embodiments, which is not repeated herein. In some embodiments, the second PHR being associated with the second spatial information may include at least one of the following:
the second PHR being associated with second antenna panel information;
the second PHR being associated with second CORESET group information;
The second PHR is associated with the second reference signal set information;
the second PHR being associated with second TCI state information;
the second PHR being associated with second beam information.

For example, the second PHR is determined according to uplink information associated with the second antenna panel, or determined according to uplink information associated with the second CORESET group, or determined according to uplink information associated with the second reference signal set, or determined according to uplink information associated with the second TCI state, or determined according to uplink information associated with the second beam.

In some embodiments, the second PHR includes a PHR corresponding to each cell in a plurality of cells. Optionally, the PHR corresponding to each cell may be determined according to the uplink information associated with the second spatial information on each cell.

For example, the second PHR includes a PHR corresponding to the second cell, and the second PHR may be determined according to second uplink information, where the second uplink information is the uplink information associated with the second spatial information on the second cell. Optionally, the second uplink information may be a PUSCH, a PUCCH or an SRS.

In some embodiments, the second MAC CE further includes second indication information, and the second indication information is used to indicate a cell corresponding to the second PHR, that is, the plurality of cells. Optionally, the plurality of cells may be indicated in a bitmap manner. For example, the second indication information includes a first bitmap, and the first bitmap includes a plurality of bits, and each bit corresponds to a cell, and a value of each bit is used to indicate whether to report the PHR of the corresponding cell. Optionally, a number of bits of the plurality of bits may be determined according to the maximum number of cells.

It should be understood that in the embodiments of the present disclosure, spatial information associated with the multi-cell PHR carried in the second MAC CE can be indicated by explicit indication information or implicit indication information, and the present disclosure does not limit the indication method of the spatial information.

In some embodiments of the present disclosure, one or more bits in the second MAC CE are used to indicate the spatial information associated with the second PHR.

In some embodiments, one or more bits of the second MAC CE are used to indicate one type of spatial information among antenna panel information, CORESET group information, reference signal set information, TCI state information and beam information associated with the second PHR.

In some embodiments, a specific number of bits of the one or more bits may be determined according to the total number of indexes or IDs included in spatial information. For example, if the one or more bits are used to indicate antenna panel information associated with the second PHR, the specific number of the one or more bits can be determined according to the total number of antenna panel information. As an example, if two panel IDs need to be indicated, the two panel IDs can be indicated through 1 bit, or, if more panel IDs need to be indicated, more bits are required, such as 2 bits, 3 bits, etc. For example, if four panel IDs need to be indicated, 2 bits are required.

Optionally, the one or more bits may be reserved bits in the MAC CE, and the spatial information associated with the PHR carried in the MAC CE is indicated to a network device through the reserved bits in the MAC CE, so that the network device can quickly acquire the PH corresponding to the spatial information.

In some cases, for the terminal device that supports reporting a PHR associated with the spatial information, such as the terminal device of 3GPP release (R) 18 and later releases, the one or more bits are used to indicate the spatial information associated with the second PHR; for the terminal device that does not support reporting the PHR associated with the spatial information, for example, for the terminal device before R18, the one or more bits are reserved bits.

In other embodiments, the one or more bits of the second MAC CE are used to indicate at least one of antenna panel information, CORESET group information, reference signal set information, TCI state information, and beam information.

For example, the second MAC CE includes at least one bit group, each bit group includes one or more bits, the each bit group corresponds to a type of spatial information, and a value of the each bit group is used to indicate target spatial information associated with the second PHR in a corresponding type of spatial information.

In some embodiments, the at least one bit group corresponds to at least one type of spatial information, and the at least one type of spatial information includes at least one of: antenna panel information, CORESET group information, reference signal set information, TCI state information, beam information.

As an example, a second MAC CE includes X bit groups, corresponding to X types of spatial information respectively, for example, X may be 1, 2 or 3, etc.

Taking X=2 as an example, the X types of spatial information may include antenna panel information and reference signal set information. Then, the second MAC CE may include 2 bit groups, such as a third bit group and a fourth bit group, which are respectively used to indicate the antenna panel information and the reference signal set information associated with the second PHR.

In some embodiments, a number of bits included in each bit group may be the same or different. For example, the number of bits may be determined according to a total number of indexes or IDs included in each type of spatial information, or the number of bits may also be determined according to a maximum value of the total number of indexes or IDs included in the each type of spatial information.

For example, the number of bits occupied by the third bit group may be determined according to the maximum number of panel IDs, or may also be determined according to the maximum value of the maximum number of indexes or IDs included in the each type of spatial information.

As an example, the total number of panel IDs is 4, the total number of CORESET group indexes is 2, the total number of reference signal set indexes is 2, the total number of TCI indications is 8, and the total number of beam IDs is 16. Then, the number of bits occupied by the third bit group can be determined according to the total number of panel IDs 4, or can be determined according to the total number of beam IDs 16. For example, the third bit group may be 2 bits, or 4 bits.

In some embodiments, for a terminal device that supports reporting a PHR associated with spatial information, such as a terminal device of R18 and later releases, the at least one bit group are used to indicate the spatial information associated with the second PHR; for the terminal device that does not support reporting a PHR associated with the spatial information, for example, for the terminal device before R18, the at least one bit group are reserved bits.

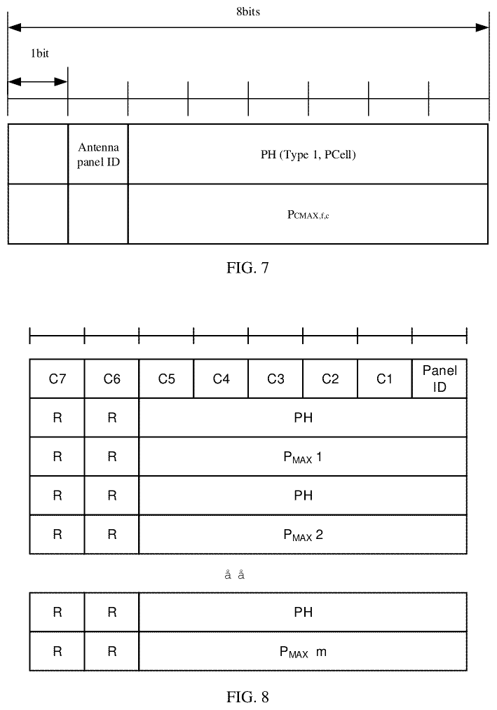

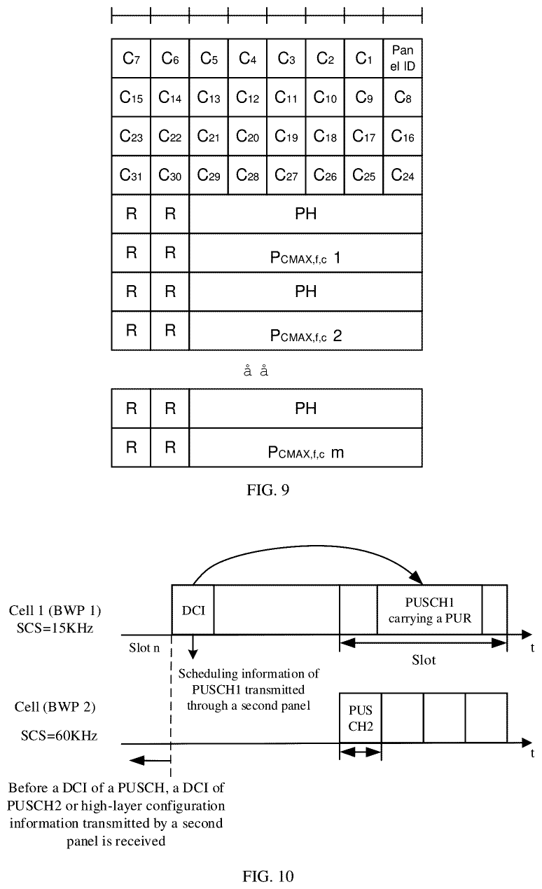

That is, for the terminal device of R18 and later releases, the at least one bit group may be interpreted as spatial information associated with the second PHR, and for the terminal device before R18, the at least one bit group may not be interpreted. In combination with FIG. 8 and FIG. 9, taking the spatial information as the panel ID as an example, a format of a MAC CE for carrying a PHR provided by the present disclosure will be described.

As shown in FIG. 8, the MAC CE includes 1 bit, and the 1 bit is used to indicate the panel ID. For example, the state 0 of the 1 bit denotes the panel ID 0, and the state 1 of the 1 bit denotes the panel ID 1. Optionally, when more types of panel IDs need to be indicated, more bits may be included.

Optionally, the MAC CE further includes a PH corresponding to a plurality of cells.

Optionally, the MAC CE further includes a maximum transmission power Pmax corresponding to each cell. For example, the maximum transmission power Pmax c corresponding to cell c may be the maximum transmission power of carrier f on the cell c, where c identifies an index of the cell and f is an index of the carrier.

Optionally, the MAC CE further includes a first bitmap (C0˜C7), where Ci is used to indicate whether to report a PHR corresponding to a serving cell with a serving cell index of i, where i=0, 1, 2, . . . , 7. For example, a value of Ci being 0 denotes that the MAC CE does not include a PHR corresponding to the serving cell with a serving cell index of i, and a value of Ci being 1 denotes that the MAC CE includes the PHR corresponding to the serving cell with a serving cell index of i. For FIG. 8, the maximum index of the serving cell is less than 8 (ServingCellIndex is less than 8), and for FIG. 9, the maximum index of the serving cell is greater than or equal to 8.

In some embodiments of the present disclosure, a MAC subheader of a second MAC CE is used to indicate spatial information associated with a second PHR. Alternatively, the spatial information associated with the second PHR is identified through the MAC subheader of the second MAC CE.

In some embodiments, a LCID in the MAC subheader of the second MAC CE is used to indicate the spatial information associated with the second PHR.

That is, the spatial information associated with a multi-cell PHR in the MAC CE carrying the multi-cell PHR is identified through the LCID of the MAC subheader. The multi-cell PHR corresponding to different spatial information is associated through the LCID value of the MAC subheader. In this case, there is no need to modify a structure of the MAC CE.

In some embodiments, LCID and spatial information are associated with each other, and therefore, the terminal device can indicate different spatial information to the network device through different LCIDs.

As an example, a codepoint and/or an index of the LCID in the MAC subheader of the second MAC CE is used to indicate the spatial information associated with the second PHR.

For example, there is an association between codepoints and/or indexes of the LCID and the spatial information, so the terminal device can indicate different spatial information to the network device through different codepoints and/or indexes of the LCID.

Taking the spatial information as a panel ID as an example, the codepoints and/or the indexes of the LCID associated with different panel IDs are different. Therefore, the network device can determine the panel associated with the multi-cell PHR in the MAC CE associated with the LCID based on the codepoints and/or the indexes of the LCID.

Taking the spatial information as the panel ID as an example, in some implementations, a LCID value corresponding to the codepoint and/or the index of the LCID is associated with the single-cell PHR with panel ID x, where x is an integer in the range of [0, N-1], and N is a total number of panels supported by the terminal device.

In some embodiments, the LCID value is the LCID value of the UL-SCH.

In some embodiments, the terminal device supports N antenna panel information, and the N antenna panel information is associated with codepoints and/or indexes of N LCID values, where N is a positive integer.

For example, when a number of reserved codepoints and/or indexes with LCID values is greater than N, and reserved codepoints and/or indexes with any N LCID values can be used to associate the multi-cell PHR associated with N panel IDs, and the LCID values corresponding to the reserved codepoints and/or indexes with the remaining LCID values are still reserved.

That is, there is an association between codepoints and/or indexes with N LCID values being reserved and the multi-cell PHR associated with N panel IDs. For example, there is a one-to-one correspondence between the codepoints and/or indexes with N LCID values being reserved and N panel IDs. Therefore, a panel associated with a multi-cell PHR in an associated MAC CE may be determined according to a LCID value of a MAC subheader.

Thus, in the embodiments of the present disclosure, by associating the LCID in the MAC subheader with the spatial information, the terminal device can set the LCID value in the MAC subheader according to the spatial information associated with the PHR, and indicate the spatial information associated with the PHR carried in the MAC CE associated with the MAC subheader through the LCID value in the MAC subheader.

Correspondingly, after receiving the MAC CE, the network device may determine the target spatial information according to the LCID in the MAC subheader associated with the MAC CE, and further determine that the PHR carried in the MAC CE is associated with the target spatial information.

It should be understood that in the embodiments of the present disclosure, the PHR is carried through the MAC CE, and the PHR is associated with the spatial information, and thus, it can be understood that the MAC CE carrying a PHR is associated with the spatial information.

Taking N as 4 as an example, an association between codepoints and/or indexes and panel IDs may be as shown in Table 3.

TABLE 3

| Codepoint/index | LCID value |
|---|---|
| 35 | Panel ID = 0 Multi-Cell PHR (maximum cell index is |
| | less than 8) |
| 36 | Panel ID = 1Multi-Cell PHR (maximum cell index is |
| | less than 8) |
| 37 | Panel ID = 2 Multi-Cell PHR (maximum cell index is |
| | less than 8) |
| 38 | Panel ID = 3 Multi-Cell PHR (maximum cell index is |
| | less than 8) |
| 39 | Panel ID = 0 Multi-Cell PHR (maximum cell index |
| | greater than or equal to 8) |
| 40 | Panel ID = 1 Multi-Cell PHR (maximum cell index |
| | greater than or equal to 8) |
| 41 | Panel ID = 2 Multi-Cell PHR (maximum cell index |
| | greater than or equal to 8) |
| 42 | Panel ID = 3 Multi-Cell PHR (maximum cell index |
| | greater than or equal to 8) |
| 43-44 | reserved |

As shown in Table 3, any 8 multi-cell PHRs with associated panel IDs 0 to 3 (including two cases: maximum cell index is less than 8 and the maximum cell index is greater than or equal to 8) among the LCID values corresponding to the codepoints and/or indexes 35-44 can be used.

As an example, the LCID values corresponding to codepoints and/or indexes 35-38 correspond to the MAC CE of multi-cell PHR with panel ID 0˜3 (the maximum cell index is less than 8), the LCID values corresponding to codepoints and/or indexes 39-42 correspond to the MAC CE of multi-cell PHR with panel ID 0˜3 (the maximum cell index is greater than or equal to 8), and the LCID values corresponding to the remaining codepoints and/or indexes are still reserved.

It should be understood that the association between the codepoints and/or indexes and the panel IDs in Table 3 is only an example. As long as different panel IDs are associated with different codepoints and/or indexes. The present disclosure does not limit thereto.

In some cases, for the terminal device that supports reporting the PHR associated with spatial information, such as for the terminal device of 3GPP release (R) 18 and later releases, the LCID values corresponding to 2N codepoints and/or indexes of codepoints and/or indexes 35-44 are associated with the multi-cell PHR corresponding to N panel IDs; for the terminal device that does not support reporting the PHR associated with the spatial information, such as the terminal device before R18, the LCID values corresponding to codepoints and/or indexes 35-44 are still reserved.

Taking N as 4 as an example, the association between codepoints and/or indexes and panel IDs may be as shown in Table 4.

TABLE 4

| Codepoint | Index | LCID value |
|---|---|---|
| 0 | 64 | Panel ID = 0 Multi-Cell PHR (maximum cell index |
| | | is less than 8) |
| 1 | 65 | Panel ID = 1 Multi-Cell PHR (maximum cell index |
| | | is less than 8) |
| 2 | 66 | Panel ID = 2 Multi-Cell PHR (maximum cell index |
| | | is less than 8) |
| 3 | 67 | Panel ID = 3 Multi-Cell PHR (maximum cell index |
| | | is less than 8) |
| 4 | 68 | Panel ID = 0 Multi-Cell PHR (maximum cell index |
| | | is greater than or equal to 8) |
| 5 | 69 | Panel ID = 1 Multi-Cell PHR (maximum cell index |
| | | is greater than or equal to 8) |
| 6 | 70 | Panel ID = 2 Multi-Cell PHR (maximum cell index |
| | | is greater than or equal to 8) |
| 7 | 71 | Panel ID = 3 Multi-Cell PHR (maximum cell index |
| | | is greater than or equal to 8) |
| 8-249 | 72-313 | reserved |

As shown in Table 4, codepoints 0-249 corresponds to indexes 64-313, and any 8 groups of the corresponding LCID values are associated with a multi-cell PHR with panel ID 0˜3. As an example, codepoints 0-3 corresponds to indexes 64-67, and corresponding LCID values correspond to a MAC CE of a multi-cell PHR with panel ID 0˜3 (the maximum cell index is less than 8). Codepoints 4-7 corresponds to indexes 68-71, and the corresponding LCID values correspond to the MAC CE of the multi-cell PHR with panel ID 0˜3 (the maximum cell index is greater than or equal to 8). The LCID values corresponding to the remaining codepoints or indexes are still reserved.

It should be understood that the association between the codepoints or indexes and the panel IDs in Table 4 is only an example. As long as different panel IDs are associated with different value combinations of codepoints and indexes, the present disclosure does not limit thereto.

In some cases, for the terminal device that supports reporting the PHR associated with spatial information, such as for the terminal device of 3GPP release (R) 18 and later releases, the LCID values corresponding to 2N groups of codepoints and indexes of the codepoints 0-249 and indexes 64-313 are associated with the multi-cell PHR corresponding to N panel IDs; for the terminal device that does not support reporting the PHR associated with the spatial information, such as the terminal device before R18, the LCID values corresponding to codepoints 0-249 and indexes 64-313 are still reserved.

In the following, in conjunction with Embodiment 2, a reporting method of a target PHR will be described.

In some embodiments of the present disclosure, a mode of the target PHR may be an actual PHR mode, or a reference PHR mode.

For the actual PHR mode, the target PHR may include a PH determined according to a power of actually transmitting uplink information. For example, if the uplink information is a PUSCH, the PH can be determined according to formula (4). For another example, if the uplink information is an SRS, the PH can be determined according to formula (6).

For the reference PHR mode, the target PHR may include a PH determined according to the reference uplink information power. For example, if the uplink information is a PUSCH, the PH can be determined according to formula (5). For another example, if the uplink information is an SRS, the PH can be determined according to formula (7).

Optionally, the reference uplink information power may be predefined or configured by a network device.

Optionally, the reference uplink information power may be a reference PUSCH power or a reference SRS power.

### Embodiment 2-1: Single-Cell PHR

In some embodiments of the present disclosure, the target PHR includes a first PHR, and the first PHR includes a single-cell PHR, and the first PHR is carried through a first MAC CE, and the first MAC CE is carried through a first PUSCH, where the first PUSCH is a PUSCH associated with the first spatial information. Herein, a specific implementation of the association between the first PUSCH and the first spatial information refers to the relevant description of the association between the uplink information and the spatial information in the aforementioned embodiments, which will not be repeated herein for the sake of brevity.

Optionally, the first PUSCH may be a PUSCH associated with a first antenna panel, or a PUSCH associated with a first CORESET group, or a PUSCH associated with a first reference signal set, or a PUSCH associated with a first TCI state, or a PUSCH associated with a first beam.

In some embodiments, the first PUSCH is an earliest originally transmitted PUSCH in the time domain position associated with the first spatial information after the terminal device determines to report the single-cell PHR. Reporting the single-cell PHR through the earliest originally transmitted PUSCH in the time domain position associated with the first spatial information is beneficial to ensure that the network device acquires the single-cell PHR reported by the terminal device as early as possible. The originally transmitted PUSCH is the PUSCH transmitted for the first time, that is, the information carried in the PUSCH is a transport block (TB) transmitted for the first time.

In other embodiments, the first PUSCH is the earliest PUSCH in the time domain position among the PUSCHs repeatedly transmitted multiple times and associated with the first spatial information after the terminal device determines to report the single-cell PHR.

For example, after the terminal device determines to report a single-cell PHR, if the first spatial information is associated with a plurality of repeatedly transmitted PUSCHs, the earliest PUSCH in the time domain position among the plurality of repeatedly transmitted PUSCHs may be selected to report the PHR. Reporting the single-cell PHR by using the earliest PUSCH in the time domain position among the plurality of repeatedly transmitted PUSCHs associated with the first spatial information is beneficial to ensure that the network device acquires the single-cell PHR reported by the terminal device as early as possible.

In some embodiments of the present disclosure, the mode of the first PHR is an actual PHR mode, and the first PHR is determined according to the power of actually transmitting the first PUSCH.

For example, the first PHR includes a PH determined according to a difference between a maximum transmission power of the terminal device and a power for actually transmitting the first PUSCH.

In some embodiments, the first PHR is a PHR of the first cell, and an UL carrier and an SUL carrier are configured on the first cell, and the terminal device may also determine uplink information of which carrier in the first cell is used, so as to determine the PHR.

For example, the PHR of the first cell is determined according to a PHR of a target carrier on the first cell. Optionally, the target carrier is determined according to whether uplink information associated with the first spatial information is configured or scheduled on a UL carrier and an SUL carrier on the first cell.

In some embodiments, if there is a carrier configured or scheduled with a PUSCH associated with the first spatial information among the UL carrier and the SUL carrier on the first cell, the carrier configured or scheduled with the PUSCH associated with the first spatial information may be selected.

As an example, if the UL carrier on the first cell is configured or scheduled with a PUSCH associated with the first spatial information, the PHR may be determined according to the PUSCH on the UL carrier. That is, the first PUSCH may be a PUSCH on the UL carrier.

As an example, if the SUL carrier on the first cell is configured or scheduled with a PUSCH associated with the first spatial information, the PHR may be determined according to the PUSCH on the SUL carrier. That is, the first PUSCH may be a PUSCH on the SUL carrier.

Optionally, if the UL carrier and the SUL carrier on the first cell are both configured or scheduled with a PUSCH associated with the first spatial information, the PUSCH on the UL carrier or the SUL carrier can be selected to determine the PHR, that is, the first PUSCH may be the PUSCH on the UL carrier or the SUL carrier.

In other embodiments, if the UL carrier and the SUL carrier on the first cell are not configured or scheduled with the PUSCH associated with the first spatial information, but the first carrier among the UL carrier and the SUL carrier on the first cell is scheduled or configured to transmit the PUSCH through third spatial information, then the PHR of the first cell is determined according to a PHR on the first carrier, where the third spatial information is different from the first spatial information.

As an example, if the UL carrier on the first cell is configured or scheduled with a PUSCH associated with the third spatial information, the PHR may be determined according to the PUSCH on the UL carrier. That is, the first PUSCH may be a PUSCH on the UL carrier.

As an example, if the SUL carrier on the first cell is configured or scheduled with a PUSCH associated with the third spatial information, the PHR may be determined according to the PUSCH on the SUL carrier. That is, the first PUSCH may be a PUSCH on the SUL carrier.

Optionally, if the UL carrier and SUL carrier on the first cell are both configured or scheduled with a PUSCH associated with the third spatial information, the PUSCH on the UL carrier or the SUL carrier can be selected to determine the PHR, that is, the first PUSCH can be the PUSCH on the UL carrier or the SUL carrier.

### Embodiment 2-2: Multi-Cell PHR

In some embodiments of the present disclosure, a target PHR includes a second PHR, and a first PHR is a multi-cell PHR, and a second PHR is carried through a second MAC CE, and the second MAC CE is carried through a second PUSCH, where the second PUSCH is a PUSCH associated with second spatial information. Herein, a specific implementation of the association between the second PUSCH and the second spatial information refers to the relevant description of the association between the uplink information and the spatial information in the aforementioned embodiments, which will not be repeated herein for the sake of brevity.

Optionally, the second PUSCH may be a PUSCH associated with a second antenna panel, or a PUSCH associated with a second CORESET group, or a PUSCH associated with a second reference signal set, or a PUSCH associated with a second TCI state, or a PUSCH associated with a second beam.

In some embodiments, the second PUSCH is an earliest originally transmitted PUSCH in the time domain position associated with the second spatial information after the terminal device determines to report the multi-cell PHR. Reporting the multi-cell PHR through the earliest originally transmitted PUSCH in the time domain position associated with the second spatial information is beneficial to ensure that the network device acquires the multi-cell PHR reported by the terminal device as early as possible.

In other embodiments, the second PUSCH is the earliest PUSCH in the time domain position among the PUSCHs repeatedly transmitted multiple times and associated with the second spatial information after the terminal device determines to report the multi-cell PHR.

For example, after the terminal device determines to report a multi-cell PHR, if the second spatial information is associated with a plurality of repeatedly transmitted PUSCHs, the earliest PUSCH in the time domain position among the plurality of repeatedly transmitted PUSCHs may be selected to report the PHR. Reporting the multi-cell PHR by using the earliest PUSCH in the time domain position among the plurality of repeatedly transmitted PUSCHs associated with the second spatial information is beneficial to ensure that the network device acquires the multi-cell PHR reported by the terminal device as early as possible.

Taking the second spatial information as the second panel for an example, as shown in FIG. 10, the multiple cells include cell 1 and cell 2. In cell 1, the terminal device receives DCI, and the DCI is used to schedule PUSCH1 sent through the second panel. In cell 2, before receiving the DCI, the terminal device receives another DCI or high-layer configuration information for scheduling PUSCH2 sent through the second panel, where the time domain position of PUSCH2 is earlier than the time domain position of PUSCH1, but PUSCH2 is a retransmitted PUSCH, then it can be determined that PUSCH1 is the PUSCH used to carry the second PHR.

In some embodiments of the present disclosure, the second PHR includes a PHR corresponding to each cell among a plurality of cells, and the PHR corresponding to each cell may be determined according to a specific PUSCH on each cell. The second PUSCH and the specific PUSCH on each cell overlap in the time domain.

In some embodiments, the plurality of cells include a second cell, and the second PHR includes a PHR corresponding to the second cell, and the PHR corresponding to the second cell is determined according to a third PUSCH on the second cell, that is, the third PUSCH is a specific PUSCH on the second cell.

In some embodiments, the third PUSCH is the actually transmitted PUSCH, and a PHR mode corresponding to the second cell is an actual PHR. A specific determination method is described below.

In other embodiments, the third PUSCH is a reference PUSCH, and the PHR mode corresponding to the second cell is a virtual PHR. A specific determination method is described below.

It should be understood that the second cell is any cell among the plurality of cells, and the implementation methods of the PHR corresponding to other cells among the plurality of cells are similar, which will not be repeated herein.

In some embodiments, if a cell where the second PUSCH is located is used as a reference cell, the third PUSCH may be determined according to a subcarrier spacing (Subcarrier spacing, SCS) of a reference cell for activating an uplink BWP and the SCS of the second cell for activating an uplink BWP, that is, it is determined that the PHR corresponding to the second cell is determined according to which PUSCH on the second cell.

For example, when the SCS of the reference cell for activating the uplink BWP is the same as the SCS of the second cell for activating the uplink BWP, at least one slot on the second cell for activating an uplink BWP overlaps with a slot where the second PUSCH is located, then a PUSCH on a first slot of the at least one slot (that is, the earliest slot in the time domain position) may be determined as a third PUSCH.

For another example, when the SCS of the reference cell for activating the uplink BWP is smaller than the SCS of the second cell for activating the uplink BWP, the slot where the second PUSCH is located overlaps with a plurality of slots of the second cell for activating the uplink BWP, then the PUSCH on the first slot among the plurality of slots that completely overlaps with the slot where the second PUSCH is located may be determined as the third PUSCH.

That is, the third PUSCH may be a PUSCH on the first slot that overlaps with the slot where the second PUSCH is located.

In some embodiments, the third PUSCH being a PUSCH on the first slot that overlaps with the slot where the second PUSCH is located may refer to: the slot where the third PUSCH is located overlaps partially or completely with the slot where the second PUSCH is located.

For example, if slots of the reference cell and the second cell are aligned, the slots where the third PUSCH and the second PUSCH are located may be completely overlapped. For another example, if the reference cell isn't aligned with the second cell, the slot where the second PUSCH is located may overlap with two slots on the second cell, and the third PUSCH may be a first slot of the two slots that overlap with the slot where the second PUSCH is located.

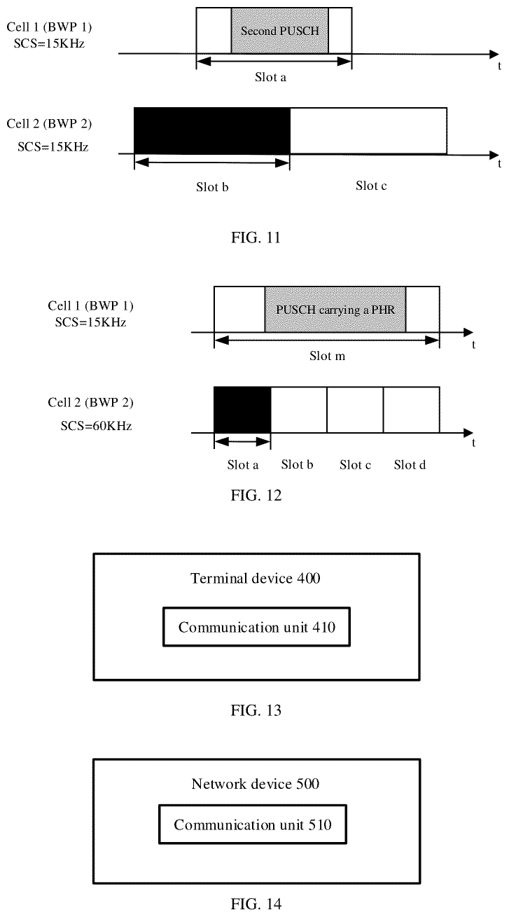

For example, as shown in FIG. 11, the SCS of the second cell is 15 KHz, and the reference cell is cell 1, and the SCS of cell 1 is 15 KHz, where the second PUSCH is transmitted on slot a, and slots overlapping with the slot a on cell 2 include slot b and slot c, where slot b is earlier than slot c, that is, the slot b is a first slot overlapping with the slot a on cell 2, then for cell 2, the PHR of the PUSCH on slot b can be reported.

In some embodiments, the third PUSCH being a PUSCH on the first slot that overlaps completely with the slot where the second PUSCH is located may refer to: the slot where the second PUSCH is located completely covers the slot where the third PUSCH is located, and the slot where the third PUSCH is located is a first slot of all slots completely covered by the slot where the second PUSCH is located.

For example, as shown in FIG. 12, the SCS of the second cell is 15 KHz, and the reference cell is cell 1, and the SCS of cell 1 is 60 KHz, where the second PUSCH is in slot m, and slots overlapping with slot m on cell 2 include slot a, slot b, slot c and slot d, where the slot a is a first slot on cell 2 that completely overlaps with slot m. For cell 2, the PHR of the PUSCH on slot a may be reported.

In some embodiments of the present disclosure, the method 200 further includes:
determining a mode of a PHR corresponding to a second cell among the multiple cells according to whether a scheduling signaling or higher-layer configuration information of a third PUSCH is received before a first reference time domain position, where the third PUSCH is a PUSCH associated with the second spatial information on the second cell.

Optionally, the scheduling signaling of the third PUSCH may include DCI.

Optionally, the higher-layer configuration information of the third PUSCH may include configuration information indicated by a higher-layer signaling (e.g., RRC signaling).

In some embodiments, it is determined that the mode of the PHR of the second cell is an actual PHR in response that the scheduling signaling or the higher-layer configuration information of the third PUSCH is received before the first reference time domain position.

Receiving the scheduling signaling or the higher-layer configuration information of the third PUSCH before the first reference time domain position indicates that a terminal device has sufficient processing time to transmit the third PUSCH and has sufficient preparation time to prepare a MAC CE carrying the second PHR. Therefore, a PHR corresponding to the second cell can be determined according to the actual power for transmitting the third PUSCH.

In other embodiments, it is determined that the mode of the PHR of the second cell is an virtual PHR in response that the scheduling signaling or the higher-layer configuration information of the third PUSCH is not received before the first reference time domain position

The scheduling signaling or the higher-layer configuration information of the third PUSCH being not received before the first reference time domain position indicates that the terminal device does not have sufficient processing time to transmit the third PUSCH and does not have sufficient preparation time to prepare the MAC CE carrying the second PHR. Therefore, the PHR corresponding to the second cell can be determined according to a reference PUSCH power.

In some embodiments, if the second PUSCH is a PUSCH scheduled by the DCI, the first reference time domain position is a last symbol of the PDCCH carrying the DCI or an end position of a monitoring occasion where the PDCCH carrying the DCI is located.

In other embodiments, if the second PUSCH is a PUSCH configured by a higher-layer signaling (such as RRC signaling), the first reference time domain position is a first time domain position before a first symbol of the second PUSCH, and a time interval between the first time domain position and a first symbol of the second PUSCH is processing time of the second PUSCH.

In some embodiments, the processing time of the second PUSCH is preparation time of the second PUSCH. For example, the processing time of the second PUSCH is T_{proc,2}=max ((N₂+d_{2,1}) (2048+144)·κ2^{-μ}·T_{C}, d_{2,2}), where d_{2,1}=1, d_{2,2}=0, N₂ is the PUSCH preparation time at a specific subcarrier spacing μ, N₂ is determined according to a processing capability of the terminal device and the specific subcarrier spacing u-min {a subcarrier spacing of the second PUSCH, a subcarrier spacing for activating downlink BWP corresponding to the second PUSCH}.

In some other embodiments, the processing time of the second PUSCH includes preparation time and additional processing time of the PUSCH. For example, the processing time of the second PUSCH is T_{proc,2}=max((N₂+d_{2,1}+T_{additional}) (2048+144)·κ2^{-μ}·T_{C}, d_{2,2}), where T_{additional} is additional processing time.

Optionally, the additional processing time is predefined, for example, the additional processing time is T_{additional} symbols, and the T_{additional} is a positive integer, e.g., 2 symbols; or, the additional processing time is determined according to the processing capacity of the terminal device; or, the additional processing time is reported through capability information of the terminal device. For example, the terminal device reports the additional processing time supported by the terminal device through third capability information of the terminal device. Candidate additional processing time can be 0 symbol, 1 symbol, 2 symbols, etc.

In some embodiments, a UL carrier and an SUL carrier are configured on the second cell, and the terminal device may also determine that uplink information of which carrier on the second cell is used, so as to determine the PHR.

For example, the PHR of the second cell is determined according to the PHR of the target carrier on the second cell. Optionally, the target carrier is determined according to whether the UL carrier and the SUL carrier on the second cell is configured or scheduled with the uplink information associated with the second spatial information.

In some embodiments, if there is a carrier configured or scheduled with a PUSCH associated with the second spatial information among the UL carrier and the SUL carrier on the second cell, the carrier configured or scheduled with the PUSCH associated with the second spatial information may be selected.

As an example, if the UL carrier on the second cell is configured or scheduled with the PUSCH associated with the second spatial information, the PHR may be determined according to the PUSCH on the UL carrier. That is, the third PUSCH may be a PUSCH on the UL carrier.

As an example, if the SUL carrier on the second cell is configured or scheduled with the PUSCH associated with the second spatial information, the PHR may be determined according to the PUSCH on the SUL carrier. That is, the third PUSCH may be a PUSCH on the SUL carrier.

Optionally, if the UL carrier and the SUL carrier on the second cell are both configured or scheduled with a PUSCH associated with the second spatial information, the PUSCH on the UL carrier or the SUL carrier can be selected to determine the PHR, that is, the third PUSCH may be the PUSCH on the UL carrier or the SUL carrier.

In other embodiments, if the UL carrier and the SUL carrier on the second cell are not configured or scheduled with the PUSCH associated with the second spatial information, but a second carrier of the UL carrier and the SUL carrier on the second cell is scheduled or configured to transmit the PUSCH through fourth spatial information, then the PHR of the second cell is determined according to the PHR on the second carrier, where the fourth spatial information is different from the second spatial information.

As an example, if the UL carrier on the second cell is configured or scheduled with the PUSCH associated with the fourth spatial information, the PHR may be determined according to the PUSCH on the UL carrier. That is, the third PUSCH may be a PUSCH on the UL carrier.

As an example, if the SUL carrier on the second cell is configured or scheduled with the PUSCH associated with the fourth spatial information, the PHR may be determined according to the PUSCH on the SUL carrier. That is, the third PUSCH may be a PUSCH on the SUL carrier.

Optionally, if the UL carrier and the SUL carrier on the second cell are both configured or scheduled with a PUSCH associated with the fourth spatial information, the PUSCH on the UL carrier or the SUL carrier can be selected to determine the PHR, that is, the third PUSCH may be the PUSCH on the UL carrier or the SUL carrier.

In some embodiments of the present disclosure, the method 200 further includes:
reporting, by the terminal device, first capability information, where the first capability information is used to indicate whether a maximum transmission power is able to be shared between a plurality pieces of uplink information of the terminal device, where the plurality pieces of uplink information are associated with a plurality pieces of spatial information. By reporting that a transmission power is shared between uplink information associated with a plurality pieces of spatial information, the transmission power may be shared between the uplink information associated with different spatial information, thereby increasing the flexibility of information transmission.

Optionally, when a plurality pieces of uplink information shares the maximum transmission power, a sum of the transmission powers of the plurality pieces of uplink information does not exceed the maximum transmission power of the terminal device. In a case where the plurality pieces of uplink information does not share the maximum transmission power, the transmission power of each uplink information does not exceed the maximum transmission power of the associated spatial information.

For example, a plurality pieces of spatial information includes spatial information 1, spatial information 2 and spatial information 3, and the maximum transmission power of the terminal device is P_{CMAX,f,c}, and each spatial information corresponds to the corresponding maximum transmission power. For example, the maximum transmission power corresponding to spatial information 1 is P1, the maximum transmission power corresponding to spatial information 2 is P2, and the maximum transmission power corresponding to spatial information 3 is P3. Then, in a case where the plurality pieces of uplink information share the maximum transmission power, the sum of the transmission powers of the uplink information related to the three types of spatial information does not exceed P, and in a case where the maximum transmission power is not updated by the plurality pieces of uplink information, the transmission power of the uplink information does not exceed the maximum transmission power of the spatial information related to the uplink information. For example, the transmission power of the uplink information related to spatial information 1 does not exceed P1, the transmission power of the uplink information related to spatial information 2 does not exceed P2, and the transmission power of the uplink information related to spatial information 2 does not exceed P3.

In some embodiments, the target maximum transmission power corresponding to each spatial information of the terminal device is a maximum transmission power determined according to each spatial information, which is beneficial to realize independent power control according to the spatial information.

Optionally, the maximum transmission power determined according to the spatial information may correspond to the maximum transmission power corresponding to the aforementioned spatial information. Optionally, the maximum transmission power corresponding to the spatial information may refer to a maximum transmission power that may be used when the uplink information is transmitted according to the spatial information. Optionally, the maximum transmission power corresponding to the spatial information is determined according to the capability of the terminal device.

In some embodiments, a target maximum transmission power corresponding to each spatial information of the terminal device is the maximum transmission power of the terminal device, or a maximum transmission power on the carrier within the cell of the terminal device, which is beneficial to realize power sharing within the terminal device (or within the carrier).

In some embodiments, the target maximum transmission power corresponding to each spatial information of the terminal device is a sum of the maximum transmission powers corresponding to all spatial information of the terminal device, which is beneficial to realize power sharing within the terminal device (or within the carrier).

In some embodiments, in a case where a plurality pieces of uplink information shares the maximum transmission power, the target maximum transmission power corresponding to each spatial information may be the maximum transmission power of the terminal device, or the sum of the maximum transmission powers corresponding to all spatial information of the terminal device.

In other embodiments, in a case where a plurality pieces of uplink information do not share a maximum transmission power, a target maximum transmission power corresponding to each spatial information may be the maximum transmission power corresponding to spatial information.

In the following, in combination with Embodiment 3, a reporting method of PHRs transmitted simultaneously by a plurality pieces of uplink information will be described.

### Embodiment 3

In some embodiments, a terminal device may transmit a plurality pieces of uplink information simultaneously, where the plurality pieces of uplink information are associated with a plurality pieces of spatial information, and the terminal device may report to a network device the PHR determined according to the plurality pieces of uplink information. That is, a target PHR may be a PHR determined according to the plurality pieces of uplink information.

For ease of distinction and explanation, in the embodiments of the present disclosure, a PHR determined according to first uplink information is recorded as a first type of PHR, and a PHR determined according to a plurality pieces of uplink information transmitted simultaneously is recorded as a second type of PHR. That is, the first type of PHR is a PHR determined according to the uplink information transmitted in association with single spatial information, and the second type of PHR is a PHR determined according to a plurality pieces of uplink information transmitted simultaneously according to a plurality pieces of spatial information.

In some embodiments, the target PHR is determined according to the sum of a maximum transmission power of the terminal device and a power for simultaneously transmitting the plurality pieces of uplink information through the plurality pieces of spatial information.

In some embodiments, the target PHR is determined according to a difference between the maximum transmission power of the terminal device and a sum of powers of the plurality pieces of uplink information. For example, the target PHR is determined according to the following formula:

$${PHR}_{obj} = {P}_{CMAX , f , c} - {\sum }_{x = 0}^{x = N - 1} {P}_{x}$$

Herein, PHR_{obj} denotes the target PHR, P_{CMAX,f,c} denotes the maximum transmission power of the terminal device, or the maximum transmission power on the carrier within a cell of the terminal device, or a sum of the maximum transmission powers corresponding to all spatial information of the terminal device, P, denotes the power for transmitting uplink information through spatial information x, and N denotes the maximum number of the spatial information supported by the terminal device.

In some embodiments of the present disclosure, the method 200 further includes:
reporting, by the terminal device, second capability information, where the second capability information is used to indicate whether the terminal device supports reporting a PHR determined according to the plurality pieces of uplink information transmitted simultaneously. Herein, the plurality pieces of uplink information are associated with the plurality pieces of spatial information, and the specific association refers to relevant description of the previous embodiments.

In some embodiments, the second capability information may also be used to indicate whether the terminal device supports transmitting the plurality pieces of uplink information simultaneously, where the plurality pieces of uplink information are associated with the plurality pieces of spatial information. That is, the terminal device may report whether transmitting the plurality pieces of uplink information simultaneously based on the plurality pieces of spatial information is supported.

Optionally, if the terminal device reports to support for simultaneously transmitting the plurality pieces of uplink information, reporting of a PHR determined according to the plurality pieces of uplink information transmitted simultaneously is supported by default.

In some embodiments, the PHR configuration information transmitted by the network device is determined according to the second capability information.

For example, when the second capability information indicates to support reporting the PHR determined according to the plurality pieces of uplink information transmitted simultaneously, the network device configures PHR configuration information associated with the plurality pieces of spatial information to the terminal device, where the PHR configuration information may be used to report the PHR of the plurality pieces of uplink information transmitted simultaneously. Furthermore, the terminal device reports the PHR determined according to the plurality pieces of uplink information transmitted simultaneously according to the PHR configuration information.

It should be understood that for the plurality pieces of uplink information transmitted simultaneously and associated with the plurality pieces of spatial information, the target PHR is a PHR determined according to the plurality pieces of uplink information, that is, the second type of PHR. It should be understood that in the embodiments of the present disclosure, the second type of PHR may also be a single-cell PHR or a multi-cell PHR.

For ease of distinction and description, the single-cell PHR and multi-cell PHR in the first type of PHR are respectively recorded as the first type of single-cell PHR and the first type of multi-cell PHR, and the single-cell PHR and multi-cell PHR in the second type of PHR are respectively recorded as the second type of single-cell PHR and the second type of multi-cell PHR.

In the embodiments of the present disclosure, a carrying method of the second type of single-cell PHR may be determined according to the method described in Embodiment 1-1, or the carrying method of the second type of multi-cell PHR may be determined according to the method described in Embodiment 1-2.

As an implementation, one or more bits in a MAC CE are used to indicate whether the MAC CE includes the second type of single-cell PHR. For example, the MAC CE includes 1 bit, and a state of the 1 bit is used to indicate whether the MAC CE includes the second type of single-cell PHR. For example, the state of the 1 bit being 1 indicates that the MAC CE includes the second type of single-cell PHR.

Optionally, the one or more bits may be reserved bits in the MAC CE. The reserved bits in the MAC CE are used to indicate to the network device that the MAC CE includes the second type of single-cell PHR, so that the network device may quickly obtain a power headroom of the terminal device.

As another implementation, a MAC subheader of the MAC CE is used to indicate whether the MAC CE includes the second type of single-cell PHR. Alternatively, the second type of single-cell PHR of the MAC CE is identified through the MAC subheader of the MAC CE.

As an example, a codepoint and/or an index of an LCID in a MAC subheader of a MAC CE is used to indicate whether the MAC CE includes the second type of single-cell PHR. The LCID value of the MAC subheader indicates whether the associated MAC CE includes the second type of single-cell PHR, without the need to modify a structure of the MAC CE. A carrying method of the second type of multi-cell PHR is similar and will not be repeated herein.

In some cases, for the terminal device that supports reporting a PHR associated with the spatial information, such as a terminal device of 3GPP release (R) 18 and later releases, the one or more bits in MAC CE are used to indicate whether the MAC CE includes the second type of single cell PHR or the second type of multi-cell PHR; for the terminal device that does not support reporting a PHR associated with the spatial information, for example, for the terminal device before R18, the one or more bits are reserved bits.

In some cases, for the terminal device that supports reporting the PHR associated with spatial information, such as for the terminal device of 3GPP release (R) 18 and later releases, the LCID value corresponding to the codepoints and/or indexes of the LCID in the MAC sub header of MAC CE are associated with the second type of single-cell PHR or the second type of multi-cell PHR; for the terminal device that does not support reporting the PHR associated with the spatial information, such as the terminal device before R18, the LCID values corresponding to codepoints and/or indexes of the LCID in the MAC sub header of MAC CE are still reserved.

In the embodiments of the present disclosure, a reporting method of the second type of single-cell PHR may be determined according to the method described in Embodiment 2-1, or the reporting method of the second type of multi-cell PHR may be determined according to the method described in Embodiment 2-2.

In some implementations, the second type of single-cell PHR may be transmitted through a fourth PUSCH. The determination method of the fourth PUSCH may refer to the determination method of the first PUSCH, which will not be repeated herein for the sake of brevity.

In some implementations, the second type of multi-cell PHR may be transmitted through a fifth PUSCH. The determination method of the fifth PUSCH may refer to the determination method of the second PUSCH, which will not be repeated herein for the sake of brevity.

It should be understood that in the embodiments of the present disclosure, the terminal device may report one type of PHR once (for example, only reporting the first type of PHR, or only reporting the second type of PHR), or may also report a plurality of types of PHR at the same time (for example, reporting the first type of PHR and the second type of PHR). The embodiments of the present disclosure does not limit the specific reporting method of the PHR of the spatial information.

For example, the terminal device reports a first target PHR, where the first target PHR includes a PHR determined according to the first uplink information and a PHR determined according to a plurality pieces of uplink information. Herein, the PHR determined according to the first uplink information is referred to first type of PHR, and the PHR determined according to a plurality pieces of uplink information is referred to second type of PHR.

It should be understood that in the embodiments of the present disclosure, the PHR configuration information transmitted by the network device may be used to configure a reporting of one type of PHR, such as the reporting of the first type of PHR, or the reporting of the second type of PHR, that is, the PHR configuration information may be used to trigger the reporting of the first type of PHR, or the reporting of the second type of PHR, or in other words, the PHR configuration information may include configuration information for the first type of PHR reporting, or include configuration information for the second type of PHR reporting. Alternatively, the configuration information transmitted by the network device may also be used to configure the reporting of a plurality of types of PHRs, e.g., a reporting of the first type PHR and the second type PHR. That is, the PHR configuration information may be used to trigger a device of the first type of PHR and the second type PHR, or in other words, the PHR configuration information may include configuration information for the first type of PHR reporting and configuration information for the second type of PHR reporting. The embodiments of the present disclosure does not limit the specific configuration method of the PHR configuration information of the spatial information granularity.

To sum up, the terminal device may receive PHR configuration information of spatial information granularity, and further report spatial information (for example, PHR, such as single-cell PHR or multi-cell PHR associated with spatial information) to the network device, or report PHR according to a plurality pieces of uplink information associated with a plurality pieces of spatial information to the network device, thereby realizing PHR reporting with spatial information granularity.

The embodiments of methods of the present disclosure is described in detail above in combination with FIGS. 6 to 12, and embodiments of apparatuses of the present disclosure is described in detail below in combination with FIGS. 13 to 17. It should be understood that the embodiments of apparatuses correspond to the embodiments of methods, and similar descriptions may refer to the descriptions of embodiments of methods.

FIG. 13 illustrates a schematic block diagram of a terminal device 400 according to the embodiments of the present disclosure. As shown in FIG. 13, the terminal device 400 includes: a communication unit 410, configured to receive power headroom report (PHR) configuration information; and report a target PHR according to the PHR configuration information.

In some embodiments, the PHR configuration information is associated with spatial information.

In some embodiments, the spatial information includes at least one of: antenna panel information, control resource set (CORESET) group information, reference signal set information, transmission configuration indicator (TCI) state information, beam information.

In some embodiments, the target PHR is a PHR determined according to first uplink information, where the first uplink information is associated with spatial information, or the target PHR is a PHR determined according to a plurality pieces of uplink information, where the plurality pieces of uplink information are associated with a plurality pieces of spatial information and the plurality pieces of uplink information are transmitted simultaneously.

In some embodiments, the PHR configuration information includes at least one of following high-layer parameters:
a periodic timer of a power headroom report;
a timer for prohibiting a PHR from reporting;
a transmission power factor change or a path loss change;
a PHR mode of an another cell group in a dual connectivity;
a cell type of a reported PHR, where the cell type of the reported PHR is multi-cell PHR or a single-cell PHR;
a reporting permission of a maximum permissible exposure (MPE);
a power management maximum power reduction (P-MPR) threshold;
a timer for prohibiting an MPE from reporting.

In some embodiments, the PHR configuration information includes first PHR configuration information and second PHR configuration information, where the first PHR configuration information is associated with first spatial information, the second PHR configuration information is associated with second spatial information, high-layer parameters included in the first PHR configuration information and the second PHR configuration are different, and/or configurations corresponding to a same high-layer parameter included in the first PHR configuration information and the second PHR configuration information are different.

In some embodiments, the first PHR configuration information being associated with the first spatial information includes at least one of:
the first PHR configuration information being associated with first antenna panel information;
the first PHR configuration information being associated with first CORESET group information;
the first PHR configuration information being associated with first reference signal set information;
the first PHR configuration information being associated with first TCI state information;
the first PHR configuration information being associated with first beam information.

In some embodiments, the second PHR configuration information being associated with the second spatial information includes at least one of:
the second PHR configuration information being associated with second antenna panel information;
the second PHR configuration information being associated with second CORESET group information;
the second PHR configuration information being associated with second reference signal set information;
the second PHR configuration information being associated with second TCI state information;
the second PHR configuration information being associated with second beam information.

In some embodiments, the first PHR configuration information includes a reporting permission of a first MPE, and the second PHR configuration information includes a reporting permission of a second MPE, where configurations corresponding to the reporting permission of the first MPE and the reporting permission of the second MPE are different.

In some embodiments, the first spatial information includes a panel ID 0, and a reporting permission of the first MPE is used to indicate that the terminal device needs to report an MPE P-MPR value in a media access control control element (MAC CE) carrying a PHR;
the second spatial information includes a panel ID 1, and a reporting permission of the second MPE is used to indicate that the terminal device does not need to report an MPE P-MPR value in the MAC CE carrying a PHR.

In some embodiments, the first PHR configuration information includes a first P-MPR threshold, and the second PHR configuration information includes a second P-MPR threshold, where the first P-MPR threshold is different from the second P-MPR threshold.

In some embodiments, the first spatial information includes a panel ID 0, and the first P-MPR threshold is 3 dB;
the second spatial information includes a panel ID 1, and the second P-MPR threshold is 6 dB.

In some embodiments, the first PHR configuration information includes a first timer for prohibiting an MPE from reporting, and the second PHR configuration information includes a second timer for prohibiting an MPE from reporting, where configurations corresponding to the first timer for prohibiting the MPE from reporting and the second timer for prohibiting the MPE from reporting are different.

In some embodiments, the first spatial information includes a panel ID 0, and a duration of the first timer for prohibiting the MPE from reporting is 10 subframes;
the second spatial information includes a panel ID 1, and a duration of the second timer for prohibiting the MPE from reporting is 20 subframes.

In some embodiments, the terminal device further includes:
a processing unit, configured to determine, according to the PHR configuration information, whether a PHR triggering condition is satisfied; and determine to report the target PHR upon the PHR triggering condition is satisfied.

In some embodiments, the target PHR includes a first PHR, where the first PHR is carried through a first media access control control element (MAC CE), and the first PHR is a PHR associated with a first spatial information.

In some embodiments, the first PHR is a single-cell PHR.

In some embodiments, one or more bits in the first MAC CE are used to indicate spatial information associated with the first PHR.

In some embodiments, for a terminal device of R18 and later versions, the one or more bits are used to indicate the spatial information associated with the first PHR; for a terminal device before R18, the one or more bits are reserved bits.

In some embodiments, the first MAC CE includes at least one bit group, each bit group includes one or more bits, the each bit group corresponds to a type of spatial information, and a value of the each bit group is used to indicate target spatial information associated with the first PHR in a corresponding type of spatial information.

In some embodiments, the at least one bit group corresponds to at least one type of spatial information, and the at least one type of spatial information includes at least one of:
antenna panel information, CORESET group information, reference signal set information, TCI state information, beam information.

In some embodiments, for a terminal device of R18 and later versions, the at least one bit group is used to indicate spatial information associated with the first PHR; for the terminal device before R18, the at least one bit group is reserved bit.

In some embodiments, a MAC subheader of the first MAC CE is used to indicate spatial information associated with the first PHR.

In some embodiments, a logical channel identity (LCID) in the MAC subheader of the first MAC CE is used to indicate the spatial information associated with the first PHR.

In some embodiments, a value of LCID in the MAC subheader of the first MAC CE is a first value used to indicate the spatial information associated with the first PHR.

In some embodiments, for a terminal device of R18 and later versions, the first value is used to indicate the spatial information associated with the first PHR. for a terminal device before R18, the first value is a reserved value.

In some embodiments, code points and/or indexes of LCIDs of MAC subheaders associated with MAC CEs associated with different pieces of spatial information are different.

In some embodiments, the terminal device supports N pieces of antenna panel information, and the N pieces of antenna panel information are associated with code points and/or indexes of N LCID values, where N is a positive integer.

In some embodiments, for a terminal device of R18 and later versions, the N LCID values are used to indicate spatial information associated with PHR; for the terminal device before R18, the N LCID values are reserved values.

In some embodiments, the first MAC CE further includes first indication information, used to indicate a cell corresponding to the PHR carried in the first MAC CE.

In some embodiments, the first MAC CE is carried through a first physical uplink shared channel (PUSCH), where the first PUSCH is a PUSCH associated with the first spatial information.

In some embodiments, the first PUSCH is an earliest originally transmitted PUSCH in a time domain position associated with the first spatial information after the terminal device determines to report a PHR determined according to first uplink information; or,

the first PUSCH is an earliest PUSCH in a time domain position among PUSCHs that are repeatedly transmitted multiple times and associated with the first spatial information after the terminal device determines to report a PHR determined according to first uplink information.

In some embodiments, a mode of the first PHR is an actual PHR, and the first PHR is determined according to a power of the first PUSCH transmitted actually.

In some embodiments, the first PHR is a PHR of a first cell, and the PHR of the first cell is determined according to a PHR of a target carrier on the first cell, where the target carrier is determined according to whether an uplink (UL) carrier and a secondary uplink (SUL) carrier on the first cell are configured or scheduled with uplink information associated with the first spatial information.

In some embodiments, the target carrier is a carrier configured or scheduled with a PUSCH associated with first spatial information among the UL carrier and the SUL carrier on the first cell; or, if a PUSCH associated with the first spatial information is not configured or scheduled with the UL carrier and the SUL carrier on the first cell, but a first carrier of the UL carrier and the SUL carrier on the first cell is scheduled or configured to transmit a PUSCH through third spatial information, then a PHR of the first cell is determined according to a PHR on the first carrier, where the third spatial information is different from the first spatial information.

In some embodiments, the target PHR includes a second PHR, and the second PHR is carried through a second MAC CE, and the second PHR is a PHR associated with second spatial information.

In some embodiments, the second PHR is a multi-cell PHR.

In some embodiments, one or more bits in the second MAC CE are used to indicate spatial information corresponding to the second PHR.

In some embodiments, for a terminal device of R18 and later versions, the one or more bits are used to indicate spatial information associated with the second PHR. for a terminal device before R18, the one or more bits are reserved bits.

In some embodiments, the second MAC CE includes at least one bit group, and each bit group includes one or more bits, and the each bit group corresponds to a type of spatial information, and a value of the each bit group is used to indicate target spatial information associated with the second PHR in a corresponding type of spatial information.

In some embodiments, the at least one bit group corresponds to at least one type of spatial information, and the at least one type of spatial information includes at least one of:
antenna panel information, CORESET group information, reference signal set information, TCI state information, beam information.

In some embodiments, for a terminal device of R18 and later versions, the at least one bit group is used to indicate spatial information associated with the second PHR. for the terminal device before R18, the at least one bit group is reserved bit.

In some embodiments, an MAC subheader of the second MAC CE is used to indicate spatial information associated with the second PHR.

In some embodiments, a LCID of the MAC subheader of the second MAC CE is used to indicate spatial information associated with the second PHR.

In some embodiments, a value of the LCID in the MAC subheader of the second MAC CE is a second value used to indicate the spatial information associated with the second PHR.

In some embodiments, for a terminal device of R18 and later versions, the second value is used to indicate the spatial information associated with the second PHR. for a terminal device before R18, the second value is a reserved value.

In some embodiments, code points and/or indexes of LCIDs of MAC subheaders associated with MAC CEs associated with different pieces of spatial information are different.

In some embodiments, the terminal device supports N pieces of antenna panel information, and the N pieces of antenna panel information are associated with code points and/or indexes of N LCID values, where N is a positive integer.

In some embodiments, for a terminal device of R18 and later versions, the N LCID values are used to indicate spatial information associated with PHR; for a terminal device before R18, the N LCID values are reserved values.

In some embodiments, the second MAC CE further includes second indication information, used to indicate a cell corresponding to a PHR carried in the second MAC CE.

In some embodiments, the second MAC CE is carried through a second PUSCH, where the second PUSCH is a PUSCH associated with the second spatial information.

In some embodiments, the second PHR includes PHRs corresponding to a plurality of cells respectively, and the terminal device further includes:
a processing unit, configured to determine a mode of a PHR corresponding to a second cell among the multiple cells according to whether a scheduling signaling or higher-layer configuration information of a third PUSCH is received before a first reference time domain position, where the third PUSCH is a PUSCH associated with the second spatial information on the second cell.

In some embodiments, the determining the mode of the PHR corresponding to the second cell among the multiple cells according to whether the scheduling signaling or the higher-layer configuration information of the third PUSCH is received before the first reference time domain position includes:
determining that the mode of the PHR of the second cell is an actual PHR in response that the scheduling signaling or the higher-layer configuration information of the third PUSCH is received before the first reference time domain position, or
determining that the mode of the PHR of the second cell is a virtual PHR in response that the scheduling signaling or the higher-layer configuration information of the third PUSCH is not received before the first reference time domain position.

In some embodiments, if the second PUSCH is a PUSCH scheduled by downlink control information (DCI), the first reference time domain position is a last symbol of the DCI or an end position of an monitoring occasion (MO) where the DCI is located; or
if the second PUSCH is a PUSCH configured by a higher-layer signaling, the first reference time domain position is a first time domain position before a first symbol of the second PUSCH, and a time interval between the first time domain position and a first symbol of the second PUSCH is processing time of the second PUSCH.

In some embodiments, the processing time of the second PUSCH is preparation time of the second PUSCH, or,
the processing time of the second PUSCH includes preparation time and additional processing time of the PUSCH, where the additional processing time is predefined or determined according to a processing capability of the terminal device.

In some embodiments, when subcarrier spacings of a reference cell and the second cell are the same, the third PUSCH is a PUSCH on a first slot that overlaps with a slot where the second PUSCH is located; or
when subcarrier spacings of a reference cell and the second cell are different, the third PUSCH is a PUSCH on a first slot that completely overlaps with the slot where the second PUSCH is located;
where the reference cell is a cell where the second PUSCH carrying the second PHR is located.

In some embodiments, the second PHR includes a PHR corresponding to a second cell, and the PHR of the second cell is determined according to a PHR of a target carrier on the second cell, where the target carrier is determined according to whether uplink information associated with the second spatial information is configured or scheduled on an UL carrier and an SUL carrier on the second cell.

In some embodiments, the target carrier is a carrier configured or scheduled with a PUSCH associated with second spatial information among an UL carrier and an SUL carrier on the second cell; or,
if the UL carrier and the SUL carrier on the second cell is not configured or scheduled with a PUSCH associated with the second spatial information, but a second carrier of the UL carrier and the SUL carrier on the second cell is scheduled or configured to transmit a PUSCH through fourth spatial information, then a PHR of the second cell is determined according to the PHR on the second carrier, where the fourth spatial information is different from the second spatial information.

In some embodiments, the communication unit 410 is further configured to: report first capability information, where the first capability information is used to indicate whether a maximum transmission power is able to be shared between the plurality pieces of uplink information associated with a plurality pieces of spatial information of the terminal device.

In some embodiments, a target maximum transmission power corresponding to each spatial information of the terminal device is a maximum transmission power determined according to the each spatial information, or the maximum transmission power of the terminal device, or a sum of the maximum transmission powers corresponding to all spatial information of the terminal device.

In some embodiments, the communication unit 410 is further configured to: report second capability information, where the second capability information is used to indicate whether the terminal device supports reporting a PHR determined according to a plurality pieces of uplink information, where the plurality pieces of uplink information are associated with a plurality pieces of spatial information and the plurality pieces of uplink information are transmitted simultaneously.

In some embodiments, the PHR configuration information is determined according to the second capability information.

In some embodiments, the target PHR is a PHR determined according to a plurality pieces of uplink information, where the plurality pieces of uplink information are associated with the plurality pieces of spatial information, and the plurality pieces of uplink information are transmitted simultaneously; where the target PHR is determined according to a maximum transmission power of a terminal device and a sum of powers of the plurality pieces of uplink information simultaneously transmitted through the plurality pieces of spatial information.

In some embodiments, the target PHR is determined according to a following formula:
where represents a target PHR, represents a maximum transmission power of the terminal device, represents a power of transmitting uplink information through spatial information x, and N represents a maximum number of spatial information supported by the terminal device.

In some embodiments, N is predefined, or N is determined according to a capability of the terminal device.

Optionally, in some embodiments, the above communication unit may be a communication interface or a transceiver, or an input/output interface of a communication chip or a system on chip. The above processing unit may be one or more processors.

It should be understood that the terminal device 400 according to the embodiments of the present disclosure may correspond to the terminal device of the method embodiments of the present disclosure, and the above and other operations and/or functions of various units in the terminal device 400 are respectively to implement the corresponding procedure of the terminal device in the method 200 shown in FIG. 6 to FIG. 12, which will not be repeated herein for the sake of brevity.

FIG. 14 is a schematic block diagram of a network device according to the embodiments of the present disclosure. The network device 500 of FIG. 14 includes:
a communication unit 510, configured to transmit power headroom report (PHR) configuration information; receive a target PHR.

In some embodiments, the PHR configuration information is associated with spatial information.

In some embodiments, the spatial information includes at least one of: antenna panel information, control resource set (CORESET) group information, reference signal set information, transmission configuration indicator (TCI) state information, beam information.

In some embodiments, the target PHR is a PHR determined according to first uplink information, where the first uplink information is associated with spatial information, or
the target PHR is a PHR determined according to a plurality pieces of uplink information, where the plurality pieces of uplink information are associated with a plurality pieces of spatial information and the plurality pieces of uplink information are transmitted simultaneously.

In some embodiments, the PHR configuration information includes at least one of following high-layer parameters: a periodic timer of a power headroom report; a timer for prohibiting a PHR from reporting; a transmission power factor change or a path loss change; a PHR mode of an another cell group in a dual connectivity; a cell type of a reported PHR, where the cell type of the reported PHR is multi-cell PHR or a single-cell PHR; a reporting permission of a maximum permissible exposure (MPE); a power management maximum power reduction (P-MPR) threshold; a timer for prohibiting an MPE from reporting.

In some embodiments, the PHR configuration information includes first PHR configuration information and second PHR configuration information, where the first PHR configuration information is associated with first spatial information, the second PHR configuration information is associated with second spatial information, high-layer parameters included in the first PHR configuration information and the second PHR configuration are different, and/or configurations corresponding to a same high-layer parameter included in the first PHR configuration information and the second PHR configuration information are different.

In some embodiments, the first PHR configuration information being associated with the first spatial information includes at least one of:
the first PHR configuration information being associated with first antenna panel information;
the first PHR configuration information being associated with first CORESET group information;
the first PHR configuration information being associated with first reference signal set information;
the first PHR configuration information being associated with first TCI state information;
the first PHR configuration information being associated with first beam information.

In some embodiments, the second PHR configuration information being associated with the second spatial information includes at least one of:
the second PHR configuration information being associated with second antenna panel information;
the second PHR configuration information being associated with second CORESET group information;
the second PHR configuration information being associated with second reference signal set information;
the second PHR configuration information being associated with second TCI state information;
the second PHR configuration information being associated with second beam information.

In some embodiments, the first PHR configuration information includes a reporting permission of a first MPE, and the second PHR configuration information includes a reporting permission of a second MPE, where configurations corresponding to the reporting permission of the first MPE and the reporting permission of the second MPE are different.

In some embodiments, the first spatial information includes a panel ID 0, and a reporting permission of the first MPE is used to indicate that the terminal device needs to report an MPE P-MPR value in a media access control control element (MAC CE) carrying a PHR;
the second spatial information includes a panel ID 1, and a reporting permission of the second MPE is used to indicate that the terminal device does not need to report an MPE P-MPR value in the MAC CE carrying a PHR.

In some embodiments, the first PHR configuration information includes a first P-MPR threshold, and the second PHR configuration information includes a second P-MPR threshold, where the first P-MPR threshold is different from the second P-MPR threshold.

In some embodiments, the first spatial information includes a panel ID 0, and the first P-MPR threshold is 3 dB;
the second spatial information includes a panel ID 1, and the second P-MPR threshold is 6 dB.

In some embodiments, the first PHR configuration information includes a first timer for prohibiting an MPE from reporting, and the second PHR configuration information includes a second timer for prohibiting an MPE from reporting, where configurations corresponding to the first timer for prohibiting the MPE from reporting and the second timer for prohibiting the MPE from reporting are different.

In some embodiments, the first spatial information includes a panel ID 0, and a duration of the first timer for prohibiting the MPE from reporting is 10 subframes; the second spatial information includes a panel ID 1, and a duration of the second timer for prohibiting the MPE from reporting is 20 subframes.

In some embodiments, the target PHR includes a first PHR, where the first PHR is carried through a first media access control control element (MAC CE), and the first PHR is a PHR associated with a first spatial information.

In some embodiments, the first PHR is a single-cell PHR.

In some embodiments, one or more bits in the first MAC CE are used to indicate spatial information associated with the first PHR.

In some embodiments, for a terminal device of R18 and later versions, the one or more bits are used to indicate the spatial information associated with the first PHR; for a terminal device before R18, the one or more bits are reserved bits.

In some embodiments, the first MAC CE includes at least one bit group, each bit group includes one or more bits, the each bit group corresponds to a type of spatial information, and a value of the each bit group is used to indicate target spatial information associated with the first PHR in a corresponding type of spatial information.

In some embodiments, the at least one bit group corresponds to at least one type of spatial information, and the at least one type of spatial information includes at least one of: antenna panel information, CORESET group information, reference signal set information, TCI state information, beam information.

In some embodiments, for a terminal device of R18 and later versions, the at least one bit group is used to indicate spatial information associated with the first PHR; for the terminal device before R18, the at least one bit group is reserved bit.

In some embodiments, a MAC subheader of the first MAC CE is used to indicate spatial information associated with the first PHR.

In some embodiments, a logical channel identity (LCID) in the MAC subheader of the first MAC CE is used to indicate the spatial information associated with the first PHR.

In some embodiments, a value of LCID in the MAC subheader of the first MAC CE is a first value used to indicate the spatial information associated with the first PHR.

In some embodiments, for a terminal device of R18 and later versions, the first value is used to indicate the spatial information associated with the first PHR. for a terminal device before R18, the first value is a reserved value.

In some embodiments, code points and/or indexes of LCIDs of MAC subheaders associated with MAC CEs associated with different pieces of spatial information are different.

In some embodiments, the terminal device supports N pieces of antenna panel information, and the N pieces of antenna panel information are associated with code points and/or indexes of N LCID values, where N is a positive integer.

In some embodiments, for a terminal device of R18 and later versions, the N LCID values are used to indicate spatial information associated with PHR; for the terminal device before R18, the N LCID values are reserved values.

In some embodiments, the first MAC CE further includes first indication information, used to indicate a cell corresponding to the PHR carried in the first MAC CE.

In some embodiments, the first MAC CE is carried through a first physical uplink shared channel (PUSCH), where the first PUSCH is a PUSCH associated with the first spatial information.

In some embodiments, the first PUSCH is an earliest originally transmitted PUSCH in a time domain position associated with the first spatial information after the terminal device determines to report a PHR determined according to first uplink information; or,
the first PUSCH is an earliest PUSCH in a time domain position among PUSCHs that are repeatedly transmitted multiple times and associated with the first spatial information after the terminal device determines to report a PHR determined according to first uplink information.

In some embodiments, a mode of the first PHR is an actual PHR, and the first PHR is determined according to a power of the first PUSCH transmitted actually.

In some embodiments, the first PHR is a PHR of a first cell, and the PHR of the first cell is determined according to a PHR of a target carrier on the first cell, where the target carrier is determined according to whether an uplink (UL) carrier and a secondary uplink (SUL) carrier on the first cell are configured or scheduled with uplink information associated with the first spatial information.

In some embodiments, the target carrier is a carrier configured or scheduled with a PUSCH associated with first spatial information among the UL carrier and the SUL carrier on the first cell; or,
if a PUSCH associated with the first spatial information is not configured or scheduled with the UL carrier and the SUL carrier on the first cell, but a first carrier of the UL carrier and the SUL carrier on the first cell is scheduled or configured to transmit a PUSCH through third spatial information, then a PHR of the first cell is determined according to a PHR on the first carrier, where the third spatial information is different from the first spatial information.

In some embodiments, the target PHR includes a second PHR, and the second PHR is carried through a second MAC CE, and the second PHR is a PHR associated with second spatial information.

In some embodiments, the second PHR is a multi-cell PHR.

In some embodiments, one or more bits in the second MAC CE are used to indicate spatial information corresponding to the second PHR.

In some embodiments, for a terminal device of R18 and later versions, the one or more bits are used to indicate spatial information associated with the second PHR. for a terminal device before R18, the one or more bits are reserved bits.

In some embodiments, the second MAC CE includes at least one bit group, and each bit group includes one or more bits, and the each bit group corresponds to a type of spatial information, and a value of the each bit group is used to indicate target spatial information associated with the second PHR in a corresponding type of spatial information.

In some embodiments, the at least one bit group corresponds to at least one type of spatial information, and the at least one type of spatial information includes at least one of: antenna panel information, CORESET group information, reference signal set information, TCI state information, beam information.

In some embodiments, for a terminal device of R18 and later versions, the at least one bit group is used to indicate spatial information associated with the second PHR. for the terminal device before R18, the at least one bit group is reserved bit.

In some embodiments, an MAC subheader of the second MAC CE is used to indicate spatial information associated with the second PHR.

In some embodiments, a LCID of the MAC subheader of the second MAC CE is used to indicate spatial information associated with the second PHR.

In some embodiments, a value of the LCID in the MAC subheader of the second MAC CE is a second value used to indicate the spatial information associated with the second PHR.

In some embodiments, for a terminal device of R18 and later versions, the second value is used to indicate the spatial information associated with the second PHR. for a terminal device before R18, the second value is a reserved value.

In some embodiments, code points and/or indexes of LCIDs of MAC subheaders associated with MAC CEs associated with different pieces of spatial information are different.

In some embodiments, the terminal device supports N pieces of antenna panel information, and the N pieces of antenna panel information are associated with code points and/or indexes of N LCID values, where N is a positive integer.

In some embodiments, for a terminal device of R18 and later versions, the N LCID values are used to indicate spatial information associated with PHR; for a terminal device before R18, the N LCID values are reserved values.

In some embodiments, the second MAC CE further includes second indication information, used to indicate a cell corresponding to a PHR carried in the second MAC CE.

In some embodiments, the second MAC CE is carried through a second PUSCH, where the second PUSCH is a PUSCH associated with the second spatial information.

In some embodiments, the communication unit 510 is further configured to: receive first capability information transmitted by a terminal device, where the first capability information is used to indicate whether a maximum transmission power is able to be shared between the plurality pieces of uplink information associated with a plurality pieces of spatial information of the terminal device.

In some embodiments, a target maximum transmission power corresponding to each spatial information of the terminal device is a maximum transmission power determined according to the each spatial information, or the maximum transmission power of the terminal device, or a sum of the maximum transmission powers corresponding to all spatial information of the terminal device.

In some embodiments, the communication unit 510 is further configured to: receive second capability information transmitted by a terminal device, where the second capability information is used to indicate whether the terminal device supports reporting a PHR determined according to a plurality pieces of uplink information, where the plurality pieces of uplink information are associated with a plurality pieces of spatial information and the plurality pieces of uplink information are transmitted simultaneously.

In some embodiments, the PHR configuration information is determined according to the second capability information.

In some embodiments, the target PHR is a PHR determined according to a plurality pieces of uplink information, where the plurality pieces of uplink information are associated with the plurality pieces of spatial information, and the plurality pieces of uplink information are transmitted simultaneously; where the target PHR is determined according to a maximum transmission power of a terminal device and a sum of powers of the plurality pieces of uplink information simultaneously transmitted through the plurality pieces of spatial information.

In some embodiments, the target PHR is determined according to a following formula:
where represents a target PHR, represents a maximum transmission power of the terminal device, represents a power of transmitting uplink information through spatial information x, and N represents a maximum number of spatial information supported by the terminal device.

In some embodiments, N is predefined, or N is determined according to a capability of the terminal device.

Optionally, in some embodiments, the above communication unit may be a communication interface or a transceiver, or an input/output interface of a communication chip or a system on chip. The above processing unit may be one or more processors.

It should be understood that the network device 500 according to the embodiments of the present disclosure may correspond to the network device of the method embodiments of the present disclosure, and the above and other operations and/or functions of various units in the network device 500 are respectively to implement the corresponding procedure of the network device in the method 200 shown in FIG. 6 to FIG. 12, which will not be repeated herein for the sake of brevity.

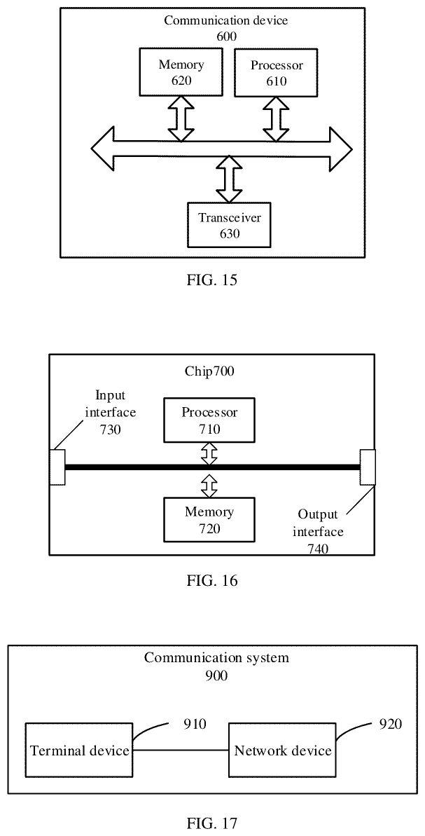

FIG. 15 is a schematic structural diagram of a communication device 600 provided by the embodiments of the present disclosure. The communication device 600 shown in FIG. 15 includes a processor 610. The processor 610 may call and run a computer program from a memory to implement the methods in the embodiments of the present disclosure.

Optionally, as shown in FIG. 15, the communication device 600 may further include a memory 620. The processor 610 can call and run a computer program from the memory 620 to implement the methods in the embodiments of the present disclosure.

Herein, the memory 620 may be a separate device independent from the processor 610, or may also be integrated into the processor 610.

Optionally, as shown in FIG. 15, the communication device 600 may further include a transceiver 630. The processor 610 can control the transceiver 630 to communicate with other devices, e.g., to transmit information or data to other devices or to receive information or data transmitted by other devices.

The transceiver 630 may include a transmitter and a receiver. The transceiver 630 may further include an antenna, where one or more antennas can be provided.

Optionally, the communication device 600 concrete may be a network device of the embodiments of this application, and the communication device 600 can implement the corresponding processes implemented by the network device in various methods of the embodiments of this application, which will not be repeated herein for brevity.

Optionally, the communication device 600 may be the mobile terminal/terminal device of the embodiments of the present disclosure, and the communication device 600 may implement the corresponding processes implemented by the mobile terminal/terminal device and in the various methods of the embodiments of the present disclosure, which will not be repeated herein for the sake of brevity.

FIG. 16 is a schematic structural diagram of a chip of the embodiments of the present disclosure. The chip 700 shown in FIG. 16 includes a processor 710, which may call and run a computer program from a memory to implement the methods in the embodiments of the present disclosure.

Optionally, as shown in FIG. 16, the chip 700 may further includes a memory 720. The processor 710 may call and run the computer program from the memory 720 to implement the methods in the embodiments of the present disclosure.

The memory 720 may be a separate device independent of the processor 710, or may be integrated into the processor 710.

Optionally, the chip 700 may further include an input interface 730. The processor 710 can control the input interface 730 to communicate with other devices or chips, e.g., to acquire information or data transmitted by other devices or chips.

Optionally, the chip 700 may further include an output interface 740. The processor 710 can control the output interface 740 to communicate with other devices or chips, e.g., to output information or data to other devices or chips.

Optionally, the chip can be applied to the network device in the embodiments of the present application, and the chip can implement the corresponding processes implemented by the network device in the various methods of the embodiments of the present application. For the sake of brevity, the details will not be repeated herein.

Optionally, the chip may be applied to the mobile terminal/terminal device in the embodiments of the present disclosure, and the chip may implement the corresponding processes implemented by the mobile terminal/terminal device and in the various methods of the embodiments of the present disclosure, which will not be repeated herein for the sake of brevity.

It should be understood that the chips mentioned in the embodiments of this application can also be called a system-level chip, a system chip, a chip system or a system-on-chip chip.

FIG. 17 is a schematic block diagram of a communication system 900 provided by embodiments of the present disclosure. As shown in FIG. 17, the communication system 900 includes a terminal device 910 and a network device 920.

Herein, the terminal device 910 may be used to implement the corresponding functions implemented by the terminal device in the above method, and the network device 920 may be used to implement the corresponding functions implemented by the network device in the above method, which will not be repeated herein for the sake of brevity.

It should be understood that the processor in the embodiments of the present disclosure may be an integrated circuit chip and has signal processing capabilities. In the process of implementation, each step of the above-mentioned method embodiments can be implemented by an integrated logic circuit of hardware in a processor an instruction in software form. The above-mentioned processor may be a general-purpose processor, a digital signal processor (DSP), an application specific integrated circuit (ASIC), a field programmable gate array (FPGA) or other programmable logic devices, a discrete gate or a transistor logic device, a discrete hardware component. The disclosed methods, steps, and logical block diagrams in the embodiments of the present disclosure can be implemented or executed. The general-purpose processor may be a microprocessor any conventional processor. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as a random memory, a flash memory, a read-only memory, a programmable read-only memory or an electrically erasable programmable memory, a register, etc. The storage medium is located in the memory, and the processor reads information in the memory and completes the steps in the above-mentioned methods in combination with its hardware.

It can be understood that the memory in the embodiments of the present disclosure may be a volatile memory or a non-volatile memory, or may include both volatile and non-volatile memories. The non-volatile memory may be a read-only memory (ROM), a programmable read-only memory (PROM), an erasable programmable read-only memory (EPROM), or an Electrically erasable programmable read-only memory (EEPROM) or a flash memory. The volatile memory may be a random access memory (RAM), which is used as an external cache. By way of illustration, but not limitation, many forms of RAMs are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM) and a direct rambus random access memory (DR RAM). It should be noted that the memories of the systems and methods described herein is intended to include, but is not limited to, these and any other suitable types of memories.

It should be understood that the above-mentioned memory is an exemplary but not restrictive description. For example, the memory in the embodiments of this application can also be static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synch link dynamic random access memory (SLDRAM), direct rambus random access memory (Direct Rambus RAM, DR RAM) etc. In other words, the memory in the embodiments of this application is intended to include, but is not limited to, these and any other suitable types of memories.

The embodiments of the present disclosure further provide a non-transitory computer readable storage medium, configured to a computer program.

Optionally, the non-transitory computer readable storage medium may be applied to the network device in the embodiments of the present disclosure, and the computer program causes a computer to perform the corresponding processes implemented by the network device and in the various methods of the embodiments of the present disclosure, which will not be repeated herein for the sake of brevity.

Optionally, the non-transitory computer readable storage medium may be applied to the mobile terminal/terminal device in the embodiments of the present disclosure, and the computer program causes a computer to perform the corresponding processes implemented by the mobile terminal/terminal device and in various methods of the embodiments of the present disclosure, which will not be repeated herein for the sake of brevity.

In the embodiments of the present disclosure, a computer program product including computer program instructions is further provided.

Optionally, the computer program product may be applied to the network device in the embodiments of the present disclosure, and the computer program instructions cause a computer to perform the corresponding processes implemented by the network device and in the various methods of the embodiments of the present disclosure, which will not be repeated herein for the sake of brevity.

Optionally, the computer program product may be applied to the mobile terminal/terminal device in the embodiments of the present disclosure, and the computer program instructions cause a computer to perform the corresponding processes implemented by the mobile terminal/terminal device and in various methods of the embodiments of the present disclosure, which will not be repeated herein for the sake of brevity.

The embodiments of the present disclosure further provide a computer program.

Optionally, the computer program may be applied to the network device in the embodiments of the present disclosure, the computer program when being executed on a computer, causes the computer to perform the corresponding processes implemented by the network device and in various methods of the embodiments of the present disclosure, which will not be repeated herein for the sake of brevity.

Optionally, the computer program may be applied to the mobile terminal/terminal device in the embodiments of the present disclosure, the computer program when being executed on a computer, causes the computer to perform the corresponding processes implemented by the mobile terminal/terminal device and in various methods of the embodiments of the present disclosure, which will not be repeated herein for the sake of brevity.

Those skilled in the art may realize that the units and algorithm steps of each example described in the disclosed embodiments can be implemented through electronic hardware, or a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present disclosure.

Those skilled in the art can clearly understand that for the convenience and brevity of the description, specific working processes of a system, an apparatus and a unit described above can refer to the corresponding processes in the foregoing method embodiments, and details are not described herein again.

In several embodiments provided by the present disclosure, it should be understood that the disclosed system, apparatus and method may be implemented in other ways. For example, the embodiments of the device described above are only illustrative. For example, the division of units is only a logical function division, and there may be other division methods for actual implementation. For example, multiple units or components can be combined or integrated into another system, or some features may be ignored or may not be executed. On the other hand, the coupling or direct coupling or communicative connection between each other as shown or discussed above may be an indirect coupling or a communicative connection via some interfaces, apparatuses or units, which may be electrical, mechanical, or in other forms.

The units described as separate components may be or may not be physically separated, and the components shown as units may be or may not be physical units, that is, they may be located in one place or distributed across multiple network units. A portion or all of the units may be selected according to actual needs to implement the purpose of the embodiments.

In addition, the functional units in the embodiments of the present disclosure may be integrated into a single processing unit or the functional units may exist physically and separately, or two or more units may be integrated into one unit.

If the described functions are implemented in a form of a software functional unit and sold or used as an independent product, they may be stored in a non-transitory computer readable storage medium. Based on this understanding, the technical solution of the present disclosure, or the portion that contributes to the existing technology or the portion of the technical solution, can be reflected in the form of a software product. The computer software product is stored in a storage medium, including several instructions to enable a computer device (which may be a personal computer, server, or network device, etc.) to perform all or a portion of the steps of the methods described in the various embodiments of the present disclosure. And the above described storage medium includes: a USB flash disk, a mobile hard disk, a read-only memory (ROM), a random access memory (RAM), a disk or a CD, and other medium that can store program code.

The foregoing descriptions are merely specific implementation manners of the preset application, but the protection scope of the preset application is not limited thereto; Any person skilled in the art could readily conceive of changes or replacements within the technical scope of the preset application, which shall all be included in the protection scope of the preset application. Therefore, the protection scope of the present application shall be subject to the protection scope of the claims.

What is claimed is:

1. A wireless communication method, comprising:
receiving, by a terminal device, power headroom report (PHR) configuration information; and
reporting, by the terminal device, a target PHR according to the PHR configuration information.

2. The method according to claim 1, wherein the PHR configuration information is associated with spatial information.

3. The method according to claim 2, wherein the spatial information comprises at least one of:
antenna panel information, control resource set (CORESET) group information, reference signal set information, transmission configuration indicator (TCI) state information, and beam information.

4. The method according to claim 1, wherein
the target PHR is a PHR determined according to first uplink information, wherein the first uplink information is associated with spatial information, or
the target PHR is a PHR determined according to a plurality pieces of uplink information, wherein the plurality pieces of uplink information are associated with a plurality pieces of spatial information and the plurality pieces of uplink information are transmitted simultaneously.

5. The method according to claim 1, wherein the PHR configuration information comprises at least one of following high-layer parameters:
a periodic timer of a power headroom report;
a timer for prohibiting a PHR from reporting;
a transmission power factor change or a path loss change;
a PHR mode of an another cell group in a dual connectivity;
a cell type of a reported PHR, wherein the cell type of the reported PHR is multi-cell PHR or a single-cell PHR;
a reporting permission of a maximum permissible exposure (MPE);
a power management maximum power reduction (P-MPR) threshold;
a timer for prohibiting an MPE from reporting.

6. The method according to claim 5, wherein the PHR configuration information comprises first PHR configuration information and second PHR configuration information, wherein the first PHR configuration information is associated with first spatial information, the second PHR configuration information is associated with second spatial information, high-layer parameters included in the first PHR configuration information and the second PHR configuration are different, and/or configurations corresponding to a same high-layer parameter included in the first PHR configuration information and the second PHR configuration information are different.

7. The method according to claim 6, wherein the first PHR configuration information being associated with the first spatial information comprises at least one of:
the first PHR configuration information being associated with first antenna panel information;
the first PHR configuration information being associated with first CORESET group information;
the first PHR configuration information being associated with first reference signal set information;
the first PHR configuration information being associated with first TCI state information;
the first PHR configuration information being associated with first beam information;
and/or the second PHR configuration information being associated with the second spatial information comprises at least one of:
the second PHR configuration information being associated with second antenna panel information;
the second PHR configuration information being associated with second CORESET group information;
the second PHR configuration information being associated with second reference signal set information;
the second PHR configuration information being associated with second TCI state information;
the second PHR configuration information being associated with second beam information.

8. The method according to claim 6, wherein the first spatial information comprises a panel ID 0, and a reporting permission of the first MPE is used to indicate that the terminal device needs to report an MPE P-MPR value in a media access control control element (MAC CE) carrying a PHR;
the second spatial information comprises a panel ID 1, and a reporting permission of the second MPE is used to indicate that the terminal device does not need to report an MPE P-MPR value in the MAC CE carrying a PHR.

9. The method according to claim 6, wherein the first PHR configuration information comprises a first P-MPR threshold, and the second PHR configuration information comprises a second P-MPR threshold, wherein the first P-MPR threshold is different from the second P-MPR threshold; wherein
the first spatial information comprises a panel ID 0, and the first P-MPR threshold is 3 dB;
the second spatial information comprises a panel ID 1, and the second P-MPR threshold is 6 dB.

10. The method according to claim 6, wherein the first PHR configuration information comprises a first timer for prohibiting an MPE from reporting, and the second PHR configuration information includes a second timer for prohibiting an MPE from reporting, wherein configurations corresponding to the first timer for prohibiting the MPE from reporting and the second timer for prohibiting the MPE from reporting are different; wherein
the first spatial information comprises a panel ID 0, and a duration of the first timer for prohibiting the MPE from reporting is 10 subframes;
the second spatial information comprises a panel ID 1, and a duration of the second timer for prohibiting the MPE from reporting is 20 subframes.

11. The method according to claim 1, wherein the method further comprises:
determining, by the terminal device according to the PHR configuration information, whether a PHR triggering condition is satisfied;
determining, by the terminal device, to report the target PHR upon the PHR triggering condition is satisfied.

12. The method according to claim 1, wherein the target PHR comprises a first PHR, wherein the first PHR is carried through a first media access control control element (MAC CE), and the first PHR is a PHR associated with a first spatial information.

13. The method according to claim 12, wherein one or more bits in the first MAC CE are used to indicate spatial information associated with the first PHR;
for a terminal device of R18 and later versions, the one or more bits are used to indicate the spatial information associated with the first PHR; for the terminal device before R18, the one or more bits are reserved bits.

14. The method according to claim 12, wherein the first MAC CE comprises at least one bit group, each bit group comprises one or more bits, the the each bit group corresponds to a type of spatial information, and a value of the each bit group is used to indicate target spatial information associated with the first PHR in a corresponding type of spatial information;
the at least one bit group corresponds to at least one type of spatial information, and the at least one type of spatial information comprises at least one of:
antenna panel information, CORESET group information, reference signal set information, TCI state information, beam information.

15. The method according to claim 12, wherein the first MAC CE is carried through a first physical uplink shared channel (PUSCH), wherein the first PUSCH is a PUSCH associated with the first spatial information.

16. The method according to claim 15, wherein
the first PUSCH is an earliest originally transmitted PUSCH in a time domain position associated with the first spatial information after the terminal device determines to report a PHR determined according to first uplink information; or,
the first PUSCH is an earliest PUSCH in a time domain position among PUSCHs that are repeatedly transmitted multiple times and associated with the first spatial information after the terminal device determines to report a PHR determined according to first uplink information.

17. The method according to claim 15, wherein a mode of the first PHR is an actual PHR, and the first PHR is determined according to a power of the first PUSCH transmitted actually.

18. The method according to claim 1, wherein a target maximum transmission power corresponding to each spatial information of the terminal device is a maximum transmission power determined according to the each spatial information, or the maximum transmission power of the terminal device, or a sum of the maximum transmission powers corresponding to all spatial information of the terminal device.

19. A terminal device, comprising:
a transceiver;
a memory, configured to store a computer program; and
a processor, configured to call and run the computer program stored in the memory; wherein the transceiver is configured to perform:
receiving power headroom report (PHR) configuration information; and
reporting a target PHR according to the PHR configuration information.

20. A network device, comprising:
a transceiver;
a memory, configured to store a computer program; and
a processor, configured to call and run the computer program stored in the memory; wherein the transceiver is configured to perform:
transmitting power headroom report (PHR) configuration information; and
receiving a target PHR.
